(19) United States
(12) Patent Application Publication
(10) Pub. No.: US 2010/0119417 A1
(43) Pub. Date: May 13, 2010

(54) DEGRADABLE FLUID HANDLING DEVICES

(75) Inventors: Arta Motadel, San Diego, CA (US); Stanley M. Preschutti, San Diego, CA (US)

Correspondence Address: GRANT ANDERSON LLP;C/O PORTFOLIOIP, P.O. BOX 52050, MINNEAPOLIS, MN, 55402, US

(73) Assignee: BIOTIX, INC., San Diego, CA (US)

(21) Appl. No.: 12/615,212

(22) Filed: Nov. 9, 2009

Related U.S. Application Data
(60) Provisional application No. 61/113,156, filed on Nov. 10, 2008.
(60) Provisional application No. 61/220,170, filed on Jun. 24, 2009.
(60) Provisional application No. 61/233,453, filed on Aug. 12, 2009.
(60) Provisional application No. 61/245,614, filed on Sep. 24, 2009.

(51) Int. Cl. B01L 3/00; B29C 51/00; B65B 1/04

(52) U.S. Cl. 422/102; 428/220; 264/320; 141/1

(57) ABSTRACT

Laboratory fluid handling devices such as reagent reservoirs, pipette tips, centrifuge tubes, test tubes, vials, and the like are used in high demand and generally are disposable and not recycled. Provided herein are biodegradable fluid handling devices that reduce negative environmental and economic effects of non-degradable plastic devices.

### RELATED PATENT APPLICATIONS

This patent application is related to U.S. Patent Application No. 61/113,156 filed on Nov. 10, 2008, entitled DEGRADABLE FLUID HANDLING DEVICES, naming Arta Motadel and Stanley Preschutti as inventors, and designated by attorney docket no. PEL-1005-PV. This patent application also is related to U.S. Patent Application No. 61/220,170 filed on Jun. 24, 2009, entitled DEGRADABLE FLUID HANDLING DEVICES, naming Arta Motadel and Stanley Preschutti as inventors, and designated by attorney docket no. PEL-1005-PV2. This patent application also is related to U.S. Patent Application No. 61/233,453 filed on Aug. 12, 2009, entitled DEGRADABLE FLUID HANDLING DEVICES, naming Arta Motadel and Stanley Preschutti as inventors, and designated by attorney docket no. PEL-1005-PV3. This patent application also is related to U.S. Patent Application No. 61/245,614 filed on Sep. 24, 2009, entitled DEGRADABLE FLUID HANDLING DEVICES, naming Arta Motadel and Stanley Preschutti as inventors, and designated by attorney docket no. PEL-1005-PV4. The entire content of the foregoing patent applications is incorporated herein by reference, including all text, tables and drawings.

### FIELD

The present technology relates to fluid handling devices. Such devices can be used in laboratories and in other settings, and can be utilized to process biological molecules.

### BACKGROUND

Plastics are used for a multitude of purposes. They are ordinarily light weight, durable, and easily molded into a variety of forms. Polyethylene is among the most common polymers used in the plastics industry. It has high tensile strength and a high melting point which provides for good blending and easy extrusion into various forms. It is especially useful in making plastic laboratory equipment, which is used in items such as reagent reservoirs, microtiter plates, pipette tips, test tubes and other fluid handling devices.

### SUMMARY

Plastics often are stable and are not capable of self-decomposition. As a result most plastics continually accumulate and contribute to increasing waste problems. Laboratory fluid handling devices such as reagent reservoirs, microtiter plates, pipette tips, test tubes, vials and the like often are molded from a plastic, generally are used in high demand, typically are disposable, and often are not reused or recycled. Reagent reservoirs, for example, can be used once or a few times, and then are disposed of. In clinics or laboratories that use automated, high-throughput procedures, a large number of fluid handling devices, such as reagent reservoirs for example, are used and then disposed, which potentially generates a significant amount of plastic waste. Disposal of plastics is a global concern due to the long term impact non-degradable materials can have on the environment. The use of degradable fluid handling devices can help reduce the environmental impact of biological research. The technology described herein, addresses, in part, problems associated with plastic stability related to fluid handling devices (e.g., environmental and economic) by providing degradable fluid handling devices.

Accordingly, provided herein is a polymer fluid handling device containing a degradable plastic (e.g., biodegradable plastic) in an amount that results in about 60 to about 90 percent decomposition within 60 to 180 days of being placed in a composting environment. In certain embodiments, the polymer fluid handling device may be selected from a pipette tip, pipette tip rack, reagent reservoir, centrifuge tube, centrifuge tube cap, syringe, petri dish, and vial. In some embodiments, the polymer fluid handling device contains degradable plastic selected from a natural polymer, a bacterial produced cellulose, and/or chemically synthesized polymeric materials. In certain embodiment where the polymer fluid handling device contains degradable natural polymer plastic, the device further comprises a plasticizer, resin, filler, and/or rheology modifying agents.

In some embodiments where the polymer fluid handling device contains chemically synthesized polymeric material, the plastic may be selected from an aliphatic polyester, an aliphatic-aromatic polyester and/or a sulfonated aliphatic-aromatic polyester. In certain embodiments, the polymer fluid handling device containing degradable plastic is photodegradable and further comprises a photosensitizer. A photodegradable plastic may further comprises iron, zinc, cerium cobalt, chromium, copper, vanadium and/or manganese compounds.

In some embodiments, the polymer fluid handling device containing degradable plastic further comprises colorants, stabilizers, antioxidants, deodorizers, flame retardants, lubricants, mold release agents or combinations thereof. The polymer fluid handling device containing degradable plastic also may further comprise a polyhydroxy-containing carboxylate, such as polyethylene glycol stearate, sorbitol palmitate, adduct of sorbitol anhydride laurate with ethylene oxide and the like; epoxidized soybean oil, oleic acid, stearic acid, and epoxy acetyl castor oil or combinations thereof. The device may further comprise maleic anhydride, methacrylic anhydride or maleimide. The device also may comprise a polymer attacking agent such as a microorganism or an enzyme.

In certain embodiments, the polymer fluid handling device comprises a coating layer, which prevents passage of gas or permeation of water, on one or more surfaces that come into contact with a liquid. A device that includes a coating layer also may comprise silicon, oxygen, carbon, hydrogen, an edible oil, a drying oil, melamine, a phenolic resin, a polyester resin, an epoxy resin, a terpene resin, a urea-formaldehyde rein, a styrene polymer, polyvinyl chloride, polyvinyl alcohol, polyvinyl acetate, a polyacrylate, a polyamide, hydroxypropylmethylcellulose, methocel, polyethylene glycol, an acrylic, an acrylic copolymer, polyurethane, polylactic acid, a polyhydroxybutyrate-hydroxyvalerate copolymer, a starch, soybean protein, a wax, and/or mixtures thereof.

In certain embodiments the degradable laboratory fluid handling device is about 15 to about 95 percent of a degradable material, or combination of degradable materials, by total device weight (e.g., about 20 to about 40, about 45 to about 65, about 50 to about 60, about 50 to about 80, about 50 to about 70, about 45 to about 55, about 30 to about 50, about 30 to about 40, about 50 to about 70, about 60 to about 80, about 60 to about 90, about 75 to about 95, about 40 to about 50, about 25 to about 50, about 25 to about 35, about 20 to about 40, about 20 to about 30, and about 15 to about 25 percent degradable material by total device weight).

Aspects of degradable fluid handling devices and related methods are described in the flowing Detailed Description, Claims and Drawings herein.

### BRIEF DESCRIPTION OF THE DRAWINGS

The drawings illustrate embodiments of the technology and are not limiting. It should be noted that for clarity and ease of illustration, these drawings are not made to scale and that in some instances various embodiments of the technology may be shown exaggerated or enlarged to facilitate an understanding of particular embodiments.

FIGS. 1A-1E illustrate various views of a biodegradable reagent reservoir device embodiment.

FIGS. 2A-2E illustrate various views of another biodegradable reagent reservoir device embodiment.

FIG. 3 shows a biodegradable pipette tip.

FIG. 4 shows a biodegradable pipette tip rack.

FIG. 5 shows a vertical cross-sectional view of a biodegradable centrifuge tube and cap embodiment.

### DETAILED DESCRIPTION

The technology described herein pertains in part to degradable fluid handling devices incorporating, carrying or coated with a degradable substance. Such devices may be utilized in a variety of fields, including, but not limited to, commercial industry, education, medical, agriculture, disease monitoring, military defense, and forensics. Devices provided herein sometimes are molded from, or sometimes comprise a component molded from, one or more degradable plastics (e.g., biodegradable plastic, photodegradable plastic). Devices provided herein sometimes are manufactured by a process that enhances hydrolysis resistance and/or heat resistance, and/or retains transparency of the device. A device provided herein can include one or more degradable plastics, including, for example, a combination of degradable materials such as natural macromolecules, microbial polyesters, accelerators, photosensitizers and/or chemosynthetic compounds. Devices provided herein may be applied in the fields of pharmacology, biotechnology, biology, chemistry, physics, medical and/or other related industries, for example. A degradable plastic often is incorporated into to a fluid handling device that can be used in a similar manner as ordinary plastic devices during use, and can degrade when placed in a composting environment.

### Degradable Plastics

Degradable plastics can be categorized into three groups: biodegradable plastics, photo-degradable plastics and plastics that are biodegradable and photodegradable. Also there are different categories of degradation. Environmental degradation of plastics generally is caused by exposure to the environmental effects of sunlight, microorganisms, insects, animals, heat, water, oxygen, wind, rain, traffic, and the like, sometimes in combination. Biodegradation is caused by the action of living organisms, such as fungi and bacteria for example. Oxidative degradation is caused by the action of oxygen and ozone. Photo-degradation results from exposure to sunlight, particularly the ultraviolet rays thereof, and to other sources of light (e.g., intense sources of light).

The term “degradable” as used herein refers to a substance that can be broken down into smaller units (e.g., into water, carbon dioxide, ammonia sulfur dioxide) by certain environmental components (e.g., water, light, microbes). The term “biodegradable” as used herein refers to a substance that can be broken down into smaller units by living organisms. Biodegradation may refer to a natural process of a material being degraded under anaerobic and/or aerobic conditions in the presence of microbes (e.g., fungi) and one or more of nutrients, carbon dioxide/methane, water, biomass and the like. Degradation may break down the multilayer structure of an object. An object subject to biodegradation may become part of a compost that is subjected to physical, chemical, thermal, and/or biological degradation in a solid waste composting or biogasification facility, in some embodiments. The term “biomass” as used herein refers to a portion of metabolized materials that is incorporated into the cellular structure of organisms present or converted to humus fractions indistinguishable from material of biological origin.

The degree of degradation can be measured by different methods. In certain embodiments, degradation occurs when about 60 to about 90 percent of a product decomposes within about 60 to about 180 days of being placed in a composting environment. In certain embodiments, the mass (e.g., weight, grams, pounds) of a product remaining, or the mass that has decomposed, after decomposition is determined. In some embodiments, the volume (e.g., cubic inches, centimeters, yards, meters; gallons, liters) of a product remaining, or the volume that has decomposed, after decomposition is determined. The mass or volume of the object(s) being degraded may be measured by any known method. In some embodiments degradation occurs when about 50 to 60, 50 to 70, 50 to 80, 60 to 70, 60 to 80, 70 to 80, or 70 to 90 percent of a product decomposes, as measured by mass or volume. In some embodiments degradation is determined after about 50 to 100, 60 to 100, 70 to 100, 80 to 100, 90 to 100, 100 to 200, 110 to 200, 120 to 200, 130 to 200, 140 to 200, 150 to 200, or 160 to 100 days have elapsed from the time an object was placed in a composting environment. For example, the litter bag method, direct observation method, harvesting litter plots, comparing paired plots, input-output structural decomposition analysis (SDA), or methods used by the American National Standards Institute and/or the American Society for Testing and Materials may be utilized in certain embodiments.

Conditions that provide more rapid or accelerated degradation, as compared to storage or use conditions, are referred to herein as “composting conditions.” Composting generally is conducted under conditions sufficient for degradation to occur (e.g. disintegration to small pieces, temperature control, inoculation with suitable microorganisms, aeration as needed, and moisture control). A composting environment sometimes is a specific environment that induces rapid or accelerated degradation, and degradation and composting often are subject to some degree of control. For example, the environment in which materials undergo physical, chemical, thermal and/or biological degradation to carbon dioxide/methane, water, and biomass can be subject to some degree of control and/or selection (e.g., a municipal solid waste composting facility). The efficiency of a composting process for biodegradation, for example, often is dependent upon the action of aerobic bacteria. Composting bacteria are most active within a somewhat limited range of oxygen, temperature and moisture contents. Therefore, the efficiency of the composting process can be enhanced by operator control of the oxygen content, temperature, and moisture content of a compost pile.

The nature of binder polymers used in plastics often determines whether a plastic is biodegradable. A reason traditional plastics may not be degradable is because their long polymer molecules are too large and too tightly bonded together to be broken apart and assimilated by decomposer organisms and/or conditions. In composting environments olefins, poly vinyl chloride, epoxides and phenolics often do not biodegrade readily. An approach to environmental degradability of articles made with synthetic polymers is to manufacture a polymer that is itself biodegradable or compostable. Plastics based on natural plant polymers derived from wheat or corn starch have molecules that are readily attacked and broken down by microbes. A synthetic material can be considered biodegradable if the extent (and optionally the rate) of biodegradation is comparable to that of naturally occurring materials (e.g., leaves, grass clippings, sawdust) or to synthetic polymers that are generally recognized as biodegradable in the same environment. The parameters of the composting environment sometimes are not constant throughout the composting process. For example, bacteriological activity in a new composting pile which contains a great deal of free organic matter is much higher than the activity in an older, more nearly fully composted pile.

Biodegradable plastics that have been developed are classified into the following four categories, which partially overlap each other: (a) naturally-occurring polymers consisting of polysaccharides (e.g., starch and the like); (b) microbial polyesters that can be degraded by the biological activities of microorganisms (e.g., polyhydroxyalkanoates and the like); (c) conventional plastics mixed with degradation accelerators (e.g., mixtures having accelerated degradation characteristics such as photosensitizers); and (d) chemosynthetic compounds (e.g., aliphatic polyesters and the like).

Plastics Produced by Natural Resources

Natural polymer degradable materials often are based on natural polymeric materials (e.g., starch and cellulose) that are chemically modified to improve physical properties (e.g., strength and the ability to repel water). Examples of degradable natural polymers include, without limitation, starch/synthetic biodegradable plastic, cellulose acetate, chitosan/cellulose/starch and denatured starch. Non-starch biodegradable components may include chitin, casein, sodium (or zinc, calcium, magnesium, potassium) phosphate and metal salt of hydrogen phosphate or dihydrogen phosphate, amide derivatives of erucamide and oleamide and the like, for example. Synthetic blends allow bacteria to colonize on the natural polymers and degrade the plastic polymers once established.

Attempts have been made to produce degradable plastics by incorporating starches into polymers. This approach, however, has contributed a unique set of problems. Starch is hydrophilic, while polyethylene is hydrophobic, and the two are not compatible with one another. Also, when more starch is introduced into a polymer, the resulting plastic film may have poor tensile strength. To incorporate starches into polymers, a general-purpose plasticizer (for example, phthalate type or fatty ester type) humectants, and/or porous aggregate may be added to the mixture to increase the flexibility (for example, injection workability, extrusion workability, stretchability, and the like) at the same levels as ordinary thermoplastic plastics (i.e. thermoplastic resin). Also, a biodegradable resin (biodegradable polymer) other than a starch ester may be added to improve the impact strength or tensile elongation of the starch ester. Polycaprolactone, polylactic acid or cellulose acetate are non-limiting examples of biodegradable resins that may be incorporated. To decrease the cost and to impart desirable properties to the final article, organic and/or inorganic fillers or aggregates can be added to the mixture in an amount greater than about 20% and up to as high as about 90% by weight of the total solids in the mixture. Non-limiting examples of organic fillers include starch, cellulose fiber, cellulose powder, wood powder, wood fiber, pulp, pecan fiber, cotton linters, lignin, grain husks, cotton powder, and the like. Examples of inorganic fillers include, without limitation, talc, titanium oxide, clay, chalk, limestone, calcium carbonate, mica, glass, silica and various silica salts, diatomaceous earth, wall austenite, various magnesium salts, various manganese salts and the like. Rheology-modifying agents, such as cellulose-based, polysaccharide-based, protein-based, and synthetic organic materials, for example, can be added to control the viscosity and yield stress of the mixture. U.S. Pat. No. 7,332,214 to Ozasa et al., U.S. Pat. No. 6,833,097 to Miyachi, and U.S. Pat. No. 6,617,449 to Tanaka all incorporated herein in their entirety by reference and for all purposes, are examples of devices composed of biodegradable plastics produced from natural polymers.

Degradable natural plastic compositions used to manufacture fluid handling devices often have one or more of the following properties: provide a stable structure and adjust to a biodegradable rate of decomposition, improve hydrolysis resistance and heat resistance, retain transparency, and are moldable. One or more of a plasticizer, resin, filler, and/or rheology modifying agent may be used in the degradable polymer composition to improve function and cost effectiveness. In certain embodiments a device can include a natural plastic, or a combination of natural plastics, in an amount of about 15 to about 95 percent by total device weight (e.g., about 20 to about 40, about 45 to about 65, about 50 to about 60, about 50 to about 80, about 50 to about 70, about 45 to about 55, about 30 to about 50, about 30 to about 40, about 50 to about 70, about 60 to about 80, about 60 to about 90, about 75 to about 95, about 40 to about 50, about 25 to about 50, about 25 to about 35, about 20 to about 40, about 20 to about 30, and about 15 to about 25 percent degradable material by total device weight).

Plastics Produced by Microbes

Degradable polymeric materials that can be used to manufacture a device often can decompose to low molecular weight substances (e.g., via microbes). Degradable microbe-produced polymeric materials often are produced by selecting microbes that can produce polyesters as energy storing substances, and the microbes can be are activated for fermentation under optimized conditions. Non-limiting examples of degradable microbe-produced polymeric materials include homopolymers, polymer blends, aliphatic polyesters, chemosynthetic compounds and the like.

Bacterial cellulose can be used for forming degradable polymers, and may contain cellulose and hetero-oligosaccharides. Without being limited by theory, in such polymers cellulose generally operates as the principal chain or glucans such as beta-1, 3 and beta-1, 2 glucans. Bacterial cellulose containing hetero-oligosaccharides also may contain components such as hexa-saccharides, penta-saccharides and organic acids such as mannose, fructose, galactose, xylose, arabinose, rhamnose and glucuronic acid, for example. Examples of microbes that can produce bacterial cellulose include, but are not limited to, Acetobacter aceti subspecies xylinum, Acetobacter pasteurianus, Acetobacter rancens, Sarcina ventriculi, Bacterium xyloides, pseudomonades and Agrobacteria.

Bacterial cellulose may contain a single polysaccharide or two or more polysaccharides existing in a mixed state under the effect of hydrogen bonds. A polymeric composite material may contain bacterial cellulose including ribbon-shaped micro-fibrils and a biodegradable polymeric material, for example. Bacterial cellulose and biodegradable polymeric material can be biologically decomposed by respective microbes living in soil and/or in water in certain embodiments, and the bacterial cellulose can improve various physical properties of the polymeric composite material including its tensile strength for example.

Polyesters can be used in degradable materials, and they often are utilized in a cost effective manner. Degradable polyesters can be described as belonging to three general classes: aliphatic polyesters, aliphatic-aromatic polyesters and sulfonated aliphatic-aromatic polyesters. Synthetic aliphatic polyesters often are synthesized from diols and dicarboxylic acids via condensation polymerization, and can completely biodegrade in soil and water. Aliphatic polyesters have better moisture resistance than starches, which have many hydroxyl groups. Aliphatic-aromatic polyesters also may be synthesized from diols and dicarboxylic acids. Sulfonated aliphatic-aromatic polyesters can be derived from a mixture of aliphatic dicarboxylic acids and aromaticdicarboxylic acids and, in addition, can incorporate a sulfonated monomer (e.g., salts of 5-sulfoisophthalic acid). In an embodiment of the present technology, these polyesters are blended with starch-based polymers for cost-competitive degradable plastic applications.

In some embodiments, degradable aliphatic polyesters include without limitation polycaprolactones, polylactic acids (PLA), polyhydroxyalkanoates (PHA), polyhydroxyhexanoate (PHH), polybutylene succinate (PBS), polycaprolactone (PCL), polyhydroxyvalerate (PHV), polyhydroxybutyrate (PHB), polybutylene succinate adipate (PBSA), PHB/PHV, PHB/PHH, and aliphatic polyesters that are polycondensed from diol and diacid, or mixtures thereof. Other degradable aliphatic-aromatic polyesters include, without limitation, modified polyethylene terephthalate (PET), aliphatic-aromatic copolyesters (AAC), polybutylene adipate/terephthalate (PBAT), and polymethylene adipate/terephthalate (PTMAT). Degradable polymeric plastics sometimes have a high hydrolytic property such that they tend to degrade by exposure to moisture in the atmosphere and hence have poor stability over time. To offset such drawbacks, compounds such as carbodiimides may be used to stabilize the structure and provide a longer lifespan for the plastics, for example. A side effect of using this compound, however, may be an undesired odor. Polycarbodiimide is another compound that may be used to stabilize against hydrolysis and sometimes results in a yellow hue as a side effect. U.S. Pat. No. 7,129,190 to Takahashi et al., U.S. Pat. No. 7,368,493 to Takahashi et al., U.S. Pat. No. 6,846,860 to Takahashi et al, U.S. Pat. No. 5,973,024 to Imashiro et al., U.S. Pat. No. 6,107,378 to Imashiro et al. all incorporated herein in their entirety by reference and for all purposes, are examples of devices that have been prepared using carbodiimides and/or polycarbodiimides.

A common commercial PHA consists of a copolymer PHB/PHV together with a plasticiser/softener (e.g. triacetine or estaflex) and inorganic additives such as titanium dioxide and calcium carbonate, for example. PHB homopolymer often is a stiff and rather brittle polymer of high crystallinity, having mechanical properties similar to polystyrene, though the former is less brittle. PHB copolymers may be used for general purposes as the degradation rate of PHB homopolymer is relatively high at its normal melt processing temperature. PHB and its copolymers with PHV are melt-processable semi-crystalline thermoplastics made by biological fermentation from renewable carbohydrate feedstocks. No toxic by-products are known to result from PHB or PHV.

Aliphatic-aromatic (AAC) copolyesters combine degradable properties of aliphatic polyesters with the strength and performance properties of aromatic polyesters. This class of degradable plastics shares similar property profiles to those of commodity polymers such as polyethylene. AACs may be blended with starch to reduce cost, for example. AACs often are closer than other biodegradable plastics to equaling the properties of low density polyethylene, especially for blown film extrusion. AACs also have other functional properties, such as transparency which is good for cling film, and flexibility and anti-fogging performance, for example.

Modified PET (polyethylene tetraphalate) is a PET that contains co-monomers, such as ether, amide and/or aliphatic monomers, the latter of which can provide ‘weak’ linkages susceptible to degradation through hydrolysis and microbial processing, for example. Modified PET can be degraded by a combination of hydrolysis of ester linkages and enzymatic attack on ether and amide bonds, for example. With modified PET it is possible to adjust and control degradation rates by varying the co-monomers used. Depending on the application, one, two or three aliphatic monomers can be incorporated into the PET structure, in some embodiments. Modified PET materials include PBAT (polybutylene adipate/terephthalate) and PTMAT (polytetramethylene adipate/terephthalate), for example. Modified PET is hydro-biodegradable, with a biodegradation step following an initial hydrolysis stage, for example.

Degradable microbe-produced plastics used to manufacture fluid handling devices often have one or more of the following properties: provide a stable structure, provide a degradable rate of decomposition, improve hydrolysis resistance and heat resistance, and retain transparency. In certain embodiments a device may include a degradable microbe-produced polymeric plastic, or combination of such plastics, in an amount of about 15 to about 95 percent by total device weight (e.g., about 20 to about 40, about 45 to about 65, about 50 to about 60, about 50 to about 80, about 50 to about 70, about 45 to about 55, about 30 to about 50, about 30 to about 40, about 50 to about 70, about 60 to about 80, about 60 to about 90, about 75 to about 95, about 40 to about 50, about 25 to about 50, about 25 to about 35, about 20 to about 40, about 20 to about 30, and about 15 to about 25 percent degradable material by total device weight).

Photodegradable Plastics and Decomposition Accelerators

Photodegradation is the decomposition of photosensitive materials initiated by a source of light. Without being bound by theory, photodegradation is degradation of a photodegradable molecule in the plastic of a device caused by the absorption of photons, particularly those wavelengths found in sunlight, such as infrared radiation, visible light and ultraviolet light. Other forms of electromagnetic radiation also can cause photodegradation. Photodegradation includes alteration of certain molecules (e.g., denaturing of proteins; addition of atoms or molecules). A common photodegradation reaction is oxidation. A photodegradable plastic contains photosensitive materials as well as biodegradable materials in certain embodiments.

Photodegradablity is an inherent property of some polymers and in certain cases it can be enhanced by the use of photosensitizing additives. Photodegradable plastics have found use in applications such as agricultural mulch film, trash bags, and retail shopping bags. U.S. Pat. No. 5,763,518 to Gnatowski et al. or U.S. Pat. No. 5,795,923 to Shahid or U.S. Pat. No. 4,476,255 to Bailey et al., all incorporated herein in their entirety by reference and for all purposes, include examples of devices composed of photodegradable plastics. A plastic composition may become photodegradable by uniformly dispersing photosensitizers throughout the body of the composition in some embodiments. In certain embodiments, photosensitizers can be organic and/or inorganic compounds and compositions that are photoreactive upon exposure to light in the ultraviolet spectrum.

Photosensitizers useful for devices herein include without limitation compounds and compositions known to promote photo-oxidation reactions, photo-polymerization reactions, photo-crosslinking reactions and the like. Photosensitizers may be aliphatic and/or aromatic ketones, including without limitation acetophenone, acetoin, l′-acetonaphthone, 2′-acetonaphtone, anisoin, anthrone, bianthrone, benzil, benzoin, benzoin methyl ether, benzoin isopropyl ether, 1-decalone, 2-decalone, benzophenone, p-chlorobenzophenone, dibenzalacetone, benzoylacetone, benzylacetone, deoxybenzoin, 2,4-dimethylbenzophenone, 2,5-dimethylbenzophenone, 3,4-dimethylbenzophenone, 4-benzoylbiphenyl, butyrophenone, 9-fluorenone, 4,4-bis-(dimethylamino)-benzophenone, 4-dimethylaminobenzophenone, dibenzyl ketone, 4-methylbenzophenone, propiophenone, benzanthrone, 1-tetralone, 2-tetralone, valerophenone, 4-nitrobenzophenone, di-n-hexyl ketone, isophorone, xanthone and the like. Aromatic ketones may be used such as benzophenone, benzoin, anthrone and deoxyanisoin.

Also useful as photosensitizers are quinones, which include, without limitation, anthraquinone, 1-aminoanthraquinone, 2-aminoanthraquinone, 1-chloroanthraquinone, 2-chloroanthraquinone, 1-methylanthraquinone, 2-methylanthraquinone, 1-nitroanthraquinone, 2-phenylanthraquinone, 1,2-naphthoquinone, 1,4-naphthoquinone, 2-methyl-1,4-naphthoquinone, 1,2-benzanthraquinone, 2,3-benzanthraquinone, phenanthrenequinone, 1-methoxyanthraquinone, 1,5-dichloroanthraquinone, and 2,2′-dimethyl-1,1′-dianthraquinone, and anthraquinone dyes. Quinones that may be used are 2-methylanthraquinone, 2-chloroanthraquinone, 2-ethylanthraquinone and the like.

Peroxides and hydroperoxides also can be used. Non-limiting examples of such compounds include tert-butyl hydroperoxide, cumene hydroperoxide, diisopropylbenzene hydroperoxide, 2,5-dimethylhexane-2,5-dihydroperoxide, p-menthane hydroperoxide, 1,1,3,3-tetramethylbutyl hydroperoxide, acetyl peroxide, benzoyl peroxide, p-chlorobenzoyl peroxide, 2,4-dichlorobenzoyl peroxide, ditoluoyl peroxide, decanoyl peroxide, lauroyl peroxide, isobutyryl peroxide, diisononanoyl peroxide, perlargonyl peroxide, tert-butyl peroxyacetate, tert-butyl peroxymaleic acid, tert-butyl peroxyisobutyrate, tert-butyl peroxypivalate, tert-butyl peroxybenzoate, tert-butyl peroxycrotonate, tert-butyl peroxy-(2-ethylhexanoate), 2,5-dimethyl-2,5-bis-(2-ethylhexanoylperoxy) hexane, 2,5-dimethyl-2,5-bis-(benzoylperoxy) hexane, 2,5-dimethyl-2,5-bis-(tert-butylperoxy) hexane, 2,5-dimethyl-2,5-bis-(tert-butylperoxy)-hexyne-3, di-tert-butyl diperoxyphthalate, 1,1,3,3-tetramethylbutylperoxy-2-ethyl-hexanoate, di-tert-butyl peroxide, di-tert-amyl peroxide, tert-amyl-tert-butyl peroxide, 1,1-di-tert-butylperoxy-3,3,5-trimethyl cyclohexane, bis-(tert-butylperoxy)-diisopropylbenzene, n-butyl-4,4-bis-(tert-butylperoxy)valerate, dicumyl peroxide, acetyl acetone peroxide, methyl ethyl ketone peroxide, cyclohexanone peroxide, tert-butylperoxy isopropyl carbonate, 2,2-bis-(tert-butylperoxy)butane, di-(2-ethylhexyl)peroxydicarbonate, bis-(4-tert-butylcyclohexyl)peroxydicarbonate and the like. Other compounds that may be used include, without limitation, benzoyl peroxide, dicumyl peroxide, dilauroyl peroxide, 2,5-dimethyl-2,5-di(t-butylperoxy) hexyne-3, and .alpha.,.alpha.′-bis(t-butylperoxy) diisopropylbenzene. Peroxides and hydroperoxides generally are thermally unstable and care must be exercised in combining a photosensitizer with a copolymer. Processing sometimes is conducted at a temperature below the decomposition temperature of the photosensitizer. Some compounds that can be used as a photosensitizer are azo compounds. Examples of azo compounds include, without limitation, 2-azo-bis-isobutyronitrile, 2-azo-bis-propionitrile, dimethyl-2-azo-bis-isobutyrate, 1-azo-bis-1-cyclohexanecarbonitrile, 2-azo-bis-2-methylheptanitrile, 2-azo-bis-2-methylbutyronitrile, 4-azo-bis-4-cyanopentanoic acid, azodicarbonamide, azobenzene, azo dyes and the like.

Biodegrading tests also have shown that the rate of photodecomposition of plastic materials and devices made from them can be accelerated by the addition of acetylacetonate or alkylbenzoyl acetate of iron, zinc, cerium cobalt, chromium, copper, vanadium and/or manganese compounds. These iron and/or manganese compounds are added in a quantity of up to about 15 percent by weight (e.g., up to about 14, 13, 12, 11, 10, 9, 8, 7, 6 and 5 percent by weight), as compared to the total weight of the remaining components, in some embodiments. Iron or manganese compounds used as decomposition accelerators may be inorganic or organic compounds in certain embodiments. Non-limiting examples of organic iron compounds that may be added are iron acetate or ferrocene or derivatives of bis-(cyclopentadienyl) iron or iron (II) acetylacetonate. Non-limiting examples of ferrocene derivatives include n-octyl ferrocene, n-octanoyl ferrocene, undecylenoyl ferrocene, .gamma.-ferrocenyl butyric acid, .gamma.-ferrocenyl butyl butyrate and the like, and thioaminocarboxylate compounds, such as iron diethyl dithiocarbamate, iron dibutyl dithiocarbamate and the like. Accelerants may be added by any known method, for example by coating, sprinkling, dipping and/or spraying in some embodiments.

Photodegradable materials used to manufacture devices herein often impart one or more of the following properties: provide a stable structure, provide a degradable rate of decomposition, improve hydrolysis resistance and heat resistance, and retain transparency. In certain embodiments a device can include a photodegradable plastic, or combination of such plastics, in an amount of about 15 to about 95 percent by total device weight (e.g., about 20 to about 40, about 45 to about 65, about 50 to about 60, about 50 to about 80, about 50 to about 70, about 45 to about 55, about 30 to about 50, about 30 to about 40, about 50 to about 70, about 60 to about 80, about 60 to about 90, about 75 to about 95, about 40 to about 50, about 25 to about 50, about 25 to about 35, about 20 to about 40, about 20 to about 30, and about 15 to about 25 percent degradable material by total device weight).

Additives and Polymer Attacking Agents

A degradable plastic may further contain, in addition to a plasticizer and filler, any other additives, such as one of more of the following non-limiting examples: colorants, stabilizers, antioxidants, deodorizers, flame retardants, lubricants, mold release agents, and the like. Any other materials that aid in degradation of a fluid handling device may be added, such as an auto-oxidizing agent. Non-limiting examples of auto-oxidizing agents include polyhydroxy-containing carboxylate, such as polyethylene glycol stearate, sorbitol palmitate, adduct of sorbitol anhydride laurate with ethylene oxide and the like; and epoxidized soybean oil, oleic acid, stearic acid, and epoxy acetyl castor oil and the like. Other additives may include coupling agents such as maleic anhydride, methacrylic anhydride or maleimide when starch and an aliphatic polyester are combined, for example.

One or more polymer attacking agents also may be used in conjunction with a degradable fluid handling device. Polymer attacking agents include, without limitation, enzymes and/or microorganisms (e.g., bacteria and fungi) that attack and cause the decay of a synthetic polymer and/or natural polymer component(s) of a degradable plastic. Anaerobic as well as aerobic bacteria may be used (e.g., Aspergillus oryzae, microorganisms recited in U.S. Pat. Nos. 3,860,490 and 3,767,790, and appropriate microorganisms listed in the American Type Culture Collection Catalogue of Fungi and Yeast 17th Ed. 1987, The Update of the Catalogue of Yeast and Fungi December 1988, The Catalogue of Bacteria and Phages 17th Ed. 1989, and the Catalohas of Microbes and Cells at Work 1st Ed. 1988). Enzymes (e.g., bacterial or fungal) that catalyze such decay (e.g., diastase, amylase and cellulase) also may be utilized.

Water often is present when a polymer attacking agent is utilized to degrade a plastic. Water can be applied in any convenient manner to the device(s). In some embodiments, water is applied to the interior of a compost environment, which can be accomplished by spraying water on the compost simultaneously with, or alternately with, turning over or churning the compost to expose dry or substantially dry areas to the water, for example. In some embodiments, a device can be degraded in conjunction with other processes, such as photodegradation, for example.

Hydro-Protective Coatings

A coating may be deposited on a degradable fluid handling device. The coating serves as a barrier coating in certain embodiments, which can perform one or more of the following functions, for example: reduce permeation of gases and/or liquids, protect plastic from chemical modification or degradation or ultraviolet radiation, provide a finished surface to the plastic, seal the plastic and/or impart extra strength to the plastic. The coating may be a film in some embodiments, and often is hydrophobic. A coating sometimes comprises a degradable plastic having similar qualities as common non-degradable plastics. A device herein (e.g., one that is mainly made of starch) can be rendered water resistant by applying a hydrophobic coating, for example.

The coating is of a chemical composition that forms a protective barrier over a portion, or all, of the surface area of a degradable device. A coating can include, without limitation, silicon, oxygen, carbon, hydrogen, an edible oil, a drying oil, melamine, a phenolic resin, a polyester resin, an epoxy resin, a terpene resin, a urea-formaldehyde rein, a styrene polymer, a polyvinyl chloride, polyvinyl alcohol, polyvinyl acetate, a polyacrylate, a polyamide, hydroxypropylmethylcellulose, methocel, polyethylene glycol, an acrylic, an acrylic copolymer, polyurethane, polylactic acid, a polyhydroxybutyrate-hydroxyvalerate copolymer, a starch, soybean protein, a wax, and a mixture thereof.

A coating may be applied by any known method, including, without limitation, evaporation coating in vacuo, chemical vapor deposition, spraying, dipping, sputtering, and/or painting. In some embodiments, a coating material can be added to a polymer mixture prior to formation of a device. If a coating material is used that has a similar melting point as the peak temperature of the mixture, it can migrate to and coat the surface of the device during manufacture. Such coating materials include certain waxes and cross-linking agents, for example. A coating may be applied as a single layer or a plurality of layers, in some embodiments. A coating may be effectively adhered directly to a device without a gap between the coating and the device (e.g., by a compress-bonding process) in some embodiments. In the latter embodiments, the coating generally is not readily peeled or removed from the surface of the device. A coating may be applied to a device using a degradable adhesive, in certain embodiments, and a coating may be attached by heating and a compress-bonding process, in some embodiments. A method for manufacturing a device herein may include first forming the coating and then forming the plastic bodies of the device, in some embodiments.

Recycled Plastics

Fluid handling devices can be manufactured from any type of recycled material. In certain embodiments, the fluid handling devices can be manufactured where one or more parts, or the entire device is made from recycled material and/or in combination with degradable materials. Recycled material can be plastic, cellulosic material or metal by any suitable method known for shaping plastics, polymers, wood or paper pulps and metals, including without limitation, molding, thermoforming, injection molding, and casting, for example. In some embodiments, recyclable plastics can be manufactured from any material known to one of skill in the art. In certain embodiments the recycled material can include by way of example, but is not limited to polypropylene (PP), polyethylene (PE), high-density polyethylene, low-density polyethylene, polyethylene teraphthalate (PET), polyvinyl chloride (PVC), polyethylenefluoroethylene (PEFE), polystyrene (PS), high-density polystyrene, acrylnitrile butadiene styrene copolymers, and bio-plastics (e.g., bio-based platform chemicals made or derived from biological materials, such as vegetable oil (e.g., canola oil), and not from petrochemicals). For example, the plastic may be recycled PET or Bio-PET (e.g., PET made from vegetable oil, and not from petrochemicals).

Bio-based plastic alternatives now exist for low and high density polyethylene (LDPE/HDPE), polypropylene (PP), polyethylene teraphthalate (PET), and polyvinyl chloride (PVC). Bio-plastic alternatives can be substituted for petroleum based plastics, where suitable, in the embodiments described herein.

Bio-PET or any type of biologically or environmentally friendly PET materials can be used in the manufacturing methods and processes of the fluid handling devices. Biologically or environmentally friendly materials can comprise any materials that are considered to inflict minimal or no harm on biological organisms or the environment, respectively. Bio-PET can be produced from a wide variety of different sources. Bio-PET can be produced from any of type of plant such as algae, for example. Other biologically or environmentally friendly PET materials may be produced from other sources such as animals, inert substances, organic materials or man-made materials.

Fluid handling devices can be manufactured from any type of environmentally friendly, earth friendly, biologically friendly, natural, organic, carbon based, basic, fundamental, elemental material. Such materials can aid in either degradation and/or recycling of the device or parts of the device. Such materials can have non-toxic properties, aid in producing less pollutants, promote an organic environment, and further support living organisms. In some embodiments a part or several parts of the device can be made from recycled or organic materials and/or in combination with degradable materials.

### Devices

The technology in part pertains to a degradable polymeric fluid handling device. Polymer reagent reservoirs, pipette tip devices and racks, laboratory fluid handling tubes, microtiter plates, centrifuge tubes and caps, laboratory vials, petri dishes, syringe devices, pipette tip filters, specimen containers, capillary tubes, blister packs, microfluidic devices and beads and/or particles that can associate with biomolecules under certain conditions that comprise biodegradable material are non-limiting examples of biodegradable fluid handling devices.

The technology in part pertains to degradable polymeric fluid handling device that also have recyclable properties. Polymer reagent reservoirs, pipette tip devices and racks, laboratory fluid handling tubes, microtiter plates, centrifuge tubes and caps, laboratory vials, petri dishes, syringe devices, pipette tip filters, specimen containers, capillary tubes, blister packs, microfluidic devices and beads and/or particles that can associate with biomolecules under certain conditions that comprise biodegradable and/or recyclable materials are non-limiting examples of biodegradable, recyclable fluid handling devices.

Certain degradable devices have antimicrobial properties, and such devices include one or more antimicrobial materials. An antimicrobial material may be impregnated in the polymer used to form a portion of or the entire device, in certain embodiments. A portion or all of a device may be coated with one or more antimicrobial materials in some embodiments. Any antimicrobial material suitable for use with a fluid handling device can be utilized, including without limitation, an antimicrobial metal, such as gold or silver or a resin comprising TRICLOSAN or chemical variant thereof mixed with polypropylene, polyethylene or polyethylene teraphthalate, for example.

Some devices are useful for the isolation, purification, concentration, processing and/or fractionation of a biological material or of a biological sample of interest. Certain devices combine and provide the benefits of chromatography, isolation, purification, concentration and or fractionation without using centrifugation. Devices described herein can be utilized in manual or automated/robotic applications in volumes ranging from sub-microliter (e.g., nanoliter) to milliliter volumes. Certain devices have the additional benefit of being readily applicable to a variety of methodologies, including pipette tip-based isolation, purification and concentration and/or fractionation of biological materials for ease of use and reduced cost. Certain devices that are useful for processing a biomolecule include a solid support that interacts with the biomolecule, in certain embodiments. The solid support in the latter embodiments can be in the form of an insert connected to the degradable device.

The terms “biomolecule,” “biological material,” “biomolecule agent” and “biomolecule reagent” as used herein refer to a material in a biological sample, specimen or source. A biological sample is any sample derived from an organism or environment, including without limitation, tissue, cells, a cell pellet, a cell extract, or a biopsy; a biological fluid such as urine, blood, saliva or amniotic fluid; exudate from a region of infection or inflammation; a mouth wash containing buccal cells; cerebral spinal fluid or synovial fluid; environmental, archeological, soil, water, agricultural sample; microorganism sample (e.g., bacterial, yeast, amoeba); organs; and the like. A biomolecule includes without limitation a cell, a group of cells, an isolated cell membrane, a cell membrane component (e.g., membrane lipid, membrane fatty acid, cholesterol, membrane protein), a saccharide, a polysaccharide, a nucleic acid (e.g., deoxyribonucleic acid (DNA), ribonucleic acid (RNA), protein nucleic acid (PNA)), a peptide and a polypeptide (e.g., a protein, a protein subunit, a protein domain) and the like. A sample sometimes is processed to liberate biomolecules of interest before a biomolecule is contacted with a device described herein. For example, cells can be lysed using methods well known in the art before the sample is contacted with a device herein.

Sample preparation devices provided herein are useful for efficient recovery of a biomolecule in a sample. Application of a metal or metal compound may also impart an antimicrobial effect to devices, which can improve the probability of sample purity and non-contamination after use of a device. In some embodiments, a sample preparation device provided herein may be used to recover about 30%, 40%, 50%, 60%, 70%, 80%, 90%, or more of a biomolecule recoverable from a sample. One may balance the purity of the starting materials with the size and purity of the sample preparation device for optimal recovery of the biological material of interest. To provide a wider range of options for the person of ordinary skill in the art, a degradable device provided herein may be configured in a number of different sizes to allow effective recovery of a material of interest from a wide range of starting materials and samples.

Fluid handling devices provided herein are useful for transport and/or delivery of a liquid or sample. Application of a metal or metal compound may also impart an antimicrobial effect to devices, which can improve the probability of sample purity and non-contamination after use of a device. In some embodiments, a sample preparation device provided herein may be used to recover about 70%, 80%, 90%, or more of a reagent or sample from the surfaces of the device. To provide a wider range of options for the person of ordinary skill in the art, a degradable device provided herein may be configured in a number of different sizes to allow effective transport, delivery and/or recovery of a reagent or sample. For example, reagent reservoirs can be configured with one or more troughs, to hold one or more liquids or samples, and the volume of liquid or sample can be the same or different in each independent trough, in some embodiments.

In certain embodiments, reagent reservoirs also can be used to isolate or purify biological molecules. Sample preparation devices provided herein are useful for efficient recovery of a biomolecule in a sample. Application of a metal or metal compound may also impart an antimicrobial effect to devices, which can improve the probability of sample purity and non-contamination after use of a device. In some embodiments, a sample preparation device provided herein may be used to recover about 30%, 40%, 50%, 60%, 70%, 80%, 90%, or more of a biomolecule recoverable from a sample. One may balance the purity of the starting materials with the size and purity of the sample preparation device for optimal recovery of the biological material of interest. To provide a wider range of options for the person of ordinary skill in the art, a degradable device provided herein may be configured in a number of different sizes to allow effective recovery of a material of interest from a wide range of starting materials and samples.

In some embodiments, a degradable fluid handling device includes a solid support that can interact with a biomolecule. Non-limiting examples of solid supports include beads, gels, fibers, capillaries and the like, or a combination thereof. A solid support may be arranged in a three-dimensional structure, such as an array, bundle, scintered arrangement and the like, for example. A solid support may be constructed from any material suitable for use with a biological molecule, including, without limitation, silica gel, glass (e.g. controlled-pore glass (CPG)), nylon, Sephadex®, Sepharose®, cellulose, a metal surface (e.g. steel, gold, silver, aluminum, silicon and copper), a magnetic material, a plastic material (e.g., polyethylene, polypropylene, polyamide, polyester, polyvinylidenedifluoride (PVDF)) and the like. One or more solid supports may be provided as an insert in effective connection with a portion of a degradable device. For example, an insert may be inserted into the inner bore of a pipette tip in some embodiments (e.g., press-fitted through the top of the pipette tip) or attached to the lid or bottom of a specimen tube in certain embodiments (e.g., by an adhesive).

Many fluid handling devices and plasticwares useful in variety of laboratory or clinical settings can be made from biodegradable plastics or polymers described herein. Non-limiting examples of fluid handling devices and plasticwares, useful in a laboratory or clinical settings, include reagent reservoirs, pipette tips, pipette tip racks, tubes, microtiter plates, centrifuge tubes and caps, laboratory vials, petri dishes, syringes and the like. Biodegradable fluid handling devices are described below.

Reagent Reservoirs

Reagent reservoirs often are used to hold and/or transport fluids dispensed using various liquid dispensing devices used in laboratory settings, for example. Reagent reservoirs allow a person or automated device to repeatedly pipette the same liquid or sample, using single or multi-channel dispensers (e.g., pipettors), in procedures and settings where a sample or reagent is dispensed into a number of containers. The dispensing device sometimes is a manual dispensing device (e.g., manual single or multi-channel pipettor) and sometimes is an automated dispensing device (e.g., robotic workstation with one or more dispensing heads configured with between 4 and 1,536 dispensing channels per head). In some embodiments, the reagent reservoir can comprise more than one independent fluid container or trough, allowing a user the option to pipette more than one fluid from a single reagent reservoir.

Accordingly, presented herein in certain embodiments are reagent reservoirs that comprise sidewalls, each sidewall including a top edge and a bottom edge and a trough including top edges, an inner channel and a base surface; where the top edge of each sidewall is connected to a top edge of the trough, the base surface of the trough and the bottom edge of each sidewall are co-planar; and the side walls and trough comprise a polymer.

Also provided herein in some embodiments are reagent reservoirs prepared by a process comprising contacting a mold with a polymer sheet and deforming the sheet on the mold, whereby a reagent reservoir is formed from the sheet; where the reagent reservoir comprises sidewalls, each sidewall including a top edge and a bottom edge; a trough including top edges, and an inner channel and a base surface; where the top edge of each sidewall is connected to a top edge of the trough, the base surface of the trough and the bottom edge of each sidewall are co-planar.

Also provided herein in certain embodiments are processes for preparing a reagent reservoir comprising contacting a mold with a polymer sheet and deforming the sheet on the mold, whereby a reagent reservoir is formed from the sheet; where the reagent reservoir comprises sidewalls, each sidewall including a top edge and a bottom edge and a trough including top edges, an inner channel and a base surface; where the top edge of each sidewall is connected to a top edge of the trough, and the base surface of the trough and the bottom edge of each sidewall are co-planar.

Also provided in some embodiments are methods for manipulating a reagent in a reagent reservoir, comprising introducing a reagent to a reagent reservoir and removing the reagent from the reagent reservoir; where the reagent reservoir comprises sidewalls, each sidewall including a top edge and a bottom edge and a trough including top edges, an inner channel and a base surface; where the top edge of each sidewall is connected to a top edge of the trough, and the base surface of the trough and the bottom edge of each sidewall are co-planar.

In some embodiments, a reagent reservoir trough can comprise an angled surface. In certain embodiments, a reagent reservoir trough comprises a substantially vertical surface. In some embodiments, a reagent reservoir trough has an inner channel. A reagent reservoir inner channel sometimes extends from longitudinally from wall to wall, in certain embodiments. In some embodiments, an inner channel does not extend from wall to wall.

A reagent reservoir inner channel can have any cross sectional shape that provides a fluid collection low point and minimizes dead volume of liquid in the reagent reservoir. The term “dead volume” as used herein, refers to a quantity of liquid that cannot be aspirated by a fluid dispensing device. The dead volume sometimes is due to the level of liquid being below the level at which the aspirating end of the dispensing device (e.g., pipette tip) forms an air tight seal by being immersed in liquid. That is, the tip of a dispensing device is not surrounded or immersed in the liquid to be aspirated and therefore aspirates air instead of, or in addition to, the desired liquid. The inner channel of reagent reservoirs described herein often are configured to provide a liquid focal point that allows substantially all liquid in the reagent reservoir to be accessed. Reagent reservoir inner channels often are longitudinal and the cross-sectional shape of the channel can be chosen from, for example, a curve, a V-shape, a flat surface, an open box shape, an arch (e.g., pointed arch, a trefoil arch, a drop arch, a keel or ogee arch also know as an ogive shape (e.g., pointed, curved surface) that can be found as a secant ogive or elliptical ogive) and the like.

In certain embodiments, a reagent reservoir trough can have a base surface. In some embodiments, a reagent reservoir trough comprises an inner channel which further comprises the trough base surface. The term “base surface” as described herein with reference to the reagent reservoir trough, refers to the underside of the trough inner channel (e.g., the underside of the lowest part of the reagent reservoir trough, or the outer surface of the lowest part of the inner channel). The base surface sometimes is formed from the lower surface of the polymer sheet, as the sheet is held in the transport/heating frame, in some embodiments, and in certain embodiments, the base surface can be formed from the upper surface of the polymer sheet, depending on the thermoforming process used. As noted above, the trough base surface and the bottom edge of the sidewalls can be co-planar.

In certain embodiments, trough surfaces comprise volumetric graduations. The volumetric graduations sometimes are in 1 milliliter increments, 5 milliliter increments, 10 milliliter increments, 25 milliliter increments or 50 milliliter increments. In some embodiments, a reagent reservoir trough can be two or more troughs, and in certain embodiments each trough may comprise independent volumetric graduations. The volumetric graduations can be bossed and/or detent in or on one or more surfaces of the reagent reservoir trough (e.g., trough slanted walls, trough substantially vertical walls, inner surface, outer surface, and the like).

In certain embodiments, an edge of the reagent reservoir trough and an edge of the reagent reservoir sidewalls can be co-extensive. In some embodiments, an edge of a reagent reservoir trough and an edge of the reagent reservoir sidewall may be connected by a joining surface. In certain embodiments, the joining surface can be a substantially horizontal surface. In some embodiments, terminal edges, formed at (i) the junction of trough inner surface edges and sidewall edges, and/or (ii) the junction of sidewall edges and substantially horizontal joining surfaces, sometimes comprise cutouts or depressions.

Reagent reservoirs often have four sidewalls, and in certain embodiments, one or more reagent reservoir sidewalls can comprise a substantially vertical surface. In some embodiments, reagent reservoir sidewalls can comprise an angled surface. In certain embodiments, reagent sidewalls comprise a flange angled with respect to the base of the substantially vertical sidewalls. In some embodiments, a trough base surface can be co-planar with the sidewall bottom edges and/or sidewall flange bottom or lower surface.

In certain embodiments, reagent reservoir sidewalls are coextensive with bossed and/or detent regions. In some embodiments, the reagent reservoir trough inner channel is coextensive with substantially perpendicular bosses and/or detent regions. In certain embodiments, the bossed and/or detent regions often further comprise between about 1 and about 20 detent and/or bossed regions per sidewall and/or channel. In some embodiments, the bossed and/or detent regions can be bossed or detent in a shape chosen from a wedge, an arch (e.g., pointed arch, a trefoil arch, a drop arch, a keel or ogee arch also know as an ogive shape (e.g., pointed, curved surface) that often are configured as a secant ogive or elliptical ogive), a groove, a double concave surface, changing radius arches, changing radius grooves, and a pyramid and the like, for example.

In some embodiments, reagent reservoir embodiments described herein can be made from polymers and/or biodegradable polymers. In certain embodiments, the polymer in the sidewalls and trough are different, and in some embodiments, the polymer in the sidewalls and trough are the same. In certain embodiments the biodegradable polymer is chosen from: naturally-occurring polymers (e.g., polysaccharides, starch and the like); microbial polyesters that can be degraded by the biological activities of microorganisms (e.g., polyhydroxyalkanoates and the like); conventional plastics mixed with degradation accelerators (e.g., mixtures having accelerated degradation characteristics such as photosensitizers); and chemosynthetic compounds (e.g., aliphatic polyesters and the like), Bio-PET, recycled Bio-PET, naturally photosensitive plastics and the like, as described in further detail below.

Reagent reservoirs described herein often are used in conjunction with high throughput automated procedures, and are therefore designed and manufactured with a sidewall bottom edge footprint configured to contact an automated dispensing device, in certain embodiments. That is, reagent reservoirs described herein sometimes conform to the American National Standards Institute (ANSI) standard dimensions, accepted by the Society for Biomolecular Sciences (SBS), for devices used in high throughput applications related to the use of microtiter plates (e.g., multi-channel dispensers (manual or automated), pipette tip racks, pipette tips, reagent reservoirs and the like), in certain embodiments, as described in greater detail hereafter. Therefore, reagent reservoirs described herein often are configured for use with a wide variety of fluid dispensing devices in laboratory and clinical settings (e.g., multi-channel pipettors [e.g., 2, 4, 8, 12, channel manual or automated pipettors], robotic multi-channel dispensing heads [e.g., 12, 24, 48, 96, 384, or 1536 channel dispensing heads] and the like).

The Society of Biomolecular Sciences (SBS)—Microplate Standards Development Committee, has developed and submitted microtiter plate standards for approval to the American National Standards Institute (ANSI), which in turn constrains the dimensions of devices and accessories used with microtiter plates. The ANSI standards for microplates were last updated Jan. 9, 2004, and can be found at World Wide Web (WWW), Uniform Resource Locator (URL), sbsonline.com/msdc/approved.php. The standards were created to help standardize equipment and accessories commonly used in high throughput automated clinical and/or laboratory settings. The microplate standardized footprint length is about 5.03 inches+/−0.02 inches and the standardized footprint width is about 3.37 inches+/−0.02 inches. The ANSI/SBS standards also set dimensions for other aspects of microtiter plates including but not limited to, well size, well spacing, distance between well centers, plate height, flange width, flange corner radii and the like.

Reagent reservoirs described herein, have a footprint length in the range of about 5.00 inches to about 5.10 inches (e.g., length of about 5.00 inches, about 5.01 inches, about 5.02 inches, about 5.03 inches, about 5.04 inches, about 5.05 inches, about 5.06 inches, about 5.07 inches, about 5.08 inches, about 5.09 inches and about 5.10 inches), measured from flange edge to flange edge across the longest dimension, in some embodiments. In certain embodiments, reagent reservoirs described herein have a footprint width in the range of about 3.33 inches to about 3.40 inches (e.g., length of about 3.33 inches, about 3.34 inches, about 3.35 inches, about 3.36 inches, about 3.37 inches, about 3.38 inches, about 3.39 inches, and about 3.40 inches), measured from flange edge to flange edge across the width of the microplate (e.g., the non-length dimension). Reagent reservoirs described herein often have a height in the range of about 0.80 to about 1.20 inches (e.g., about 0.80, 0.85, 0.90, 0.95, 1.00, 1.05, 1.10, 1.15, or about 1.20 inches), measured from flange edge to sidewall top edge.

Fluid handling devices described herein often are made by a thermoforming process. The plastic or polymer material used in the thermoforming process can be considered to have an upper surface and a lower surface, when the material is held in preparation for contacting with the mold used in thermoforming. The deforming process used creates three dimensional shapes which sometimes have upper surfaces, lower surfaces, inner surfaces, outer surfaces, and the like. Description of the fluid handling device sometimes will refer to a device surface. In some embodiments, the upper surface of the plastic or polymer material, with reference to the orientation of the material prior to mold contact, can form inner surfaces of the molded device, outer surfaces of the molded device, upper surfaces of the molded device, lower surfaces of the molded device or combinations thereof. Thermoforming is described in more detail below.

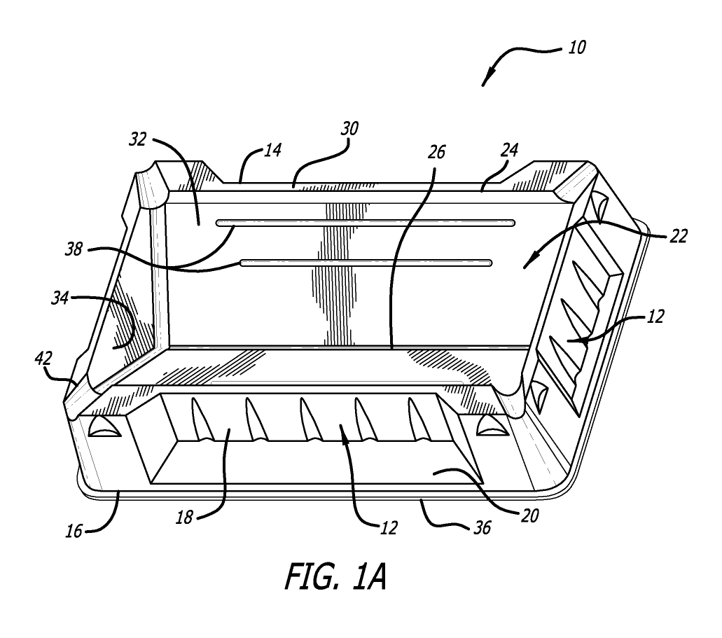

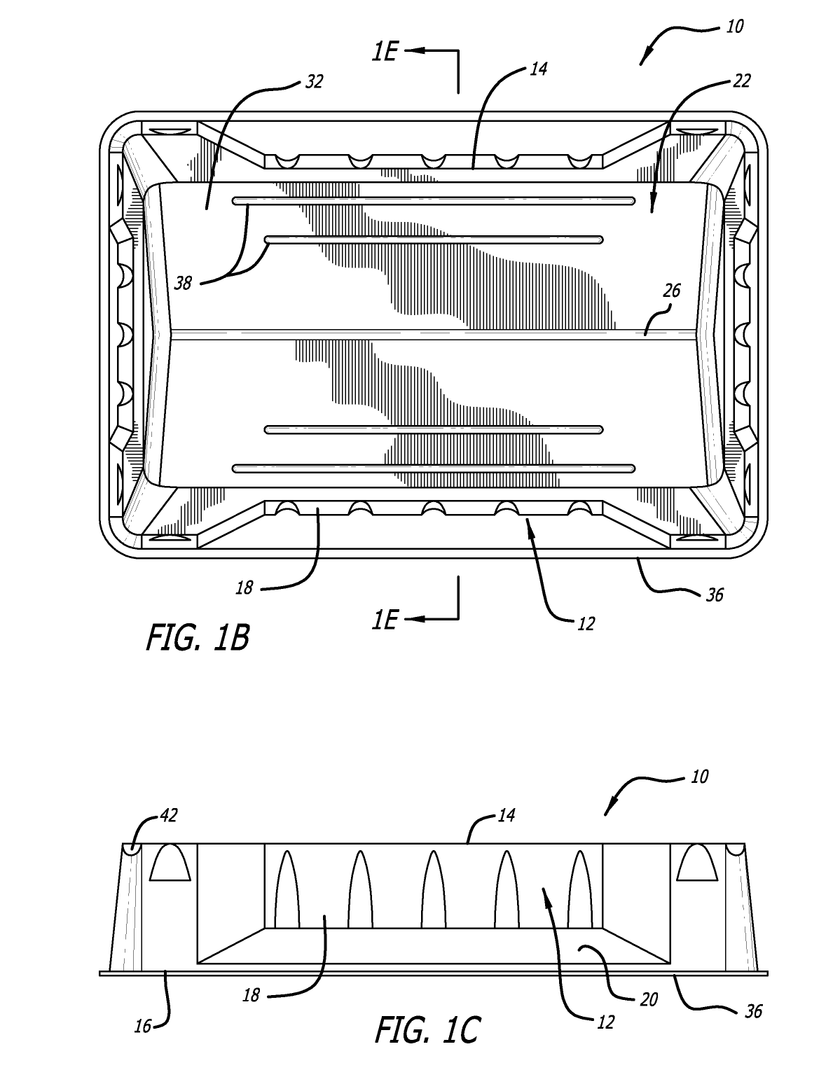

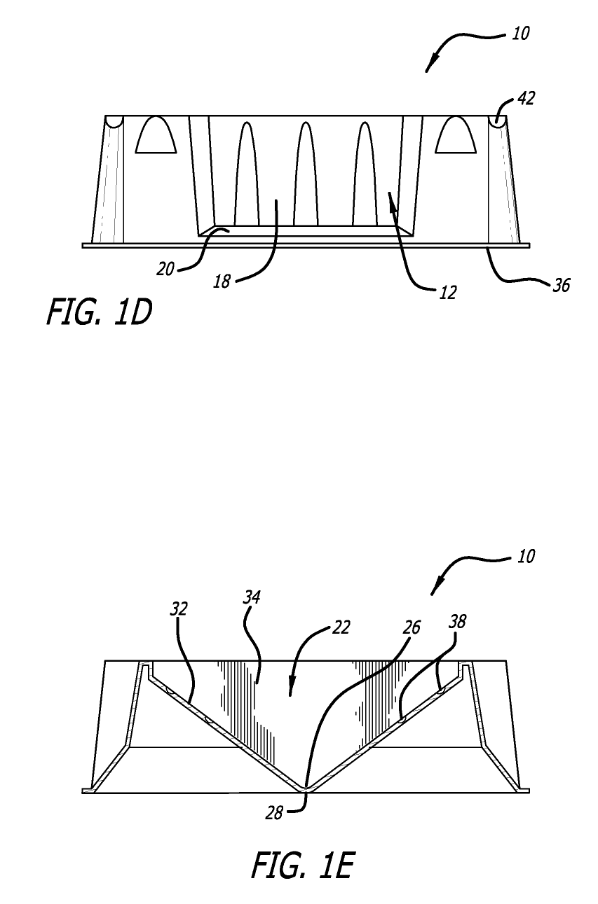

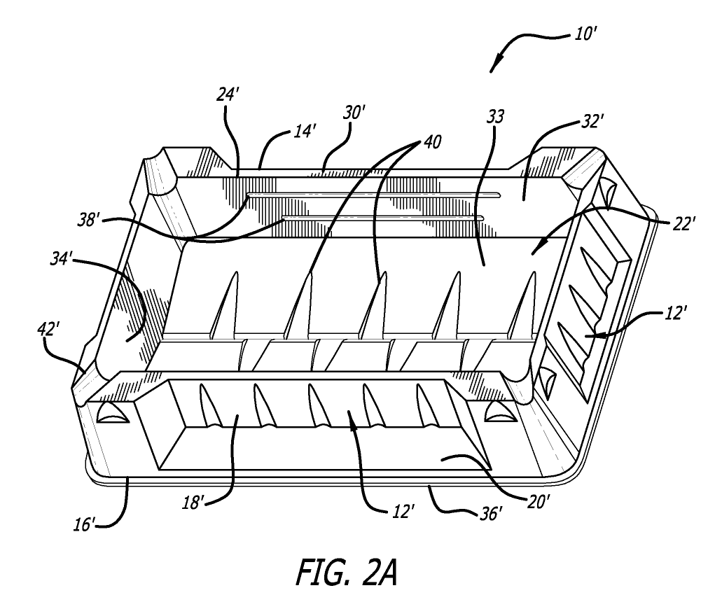

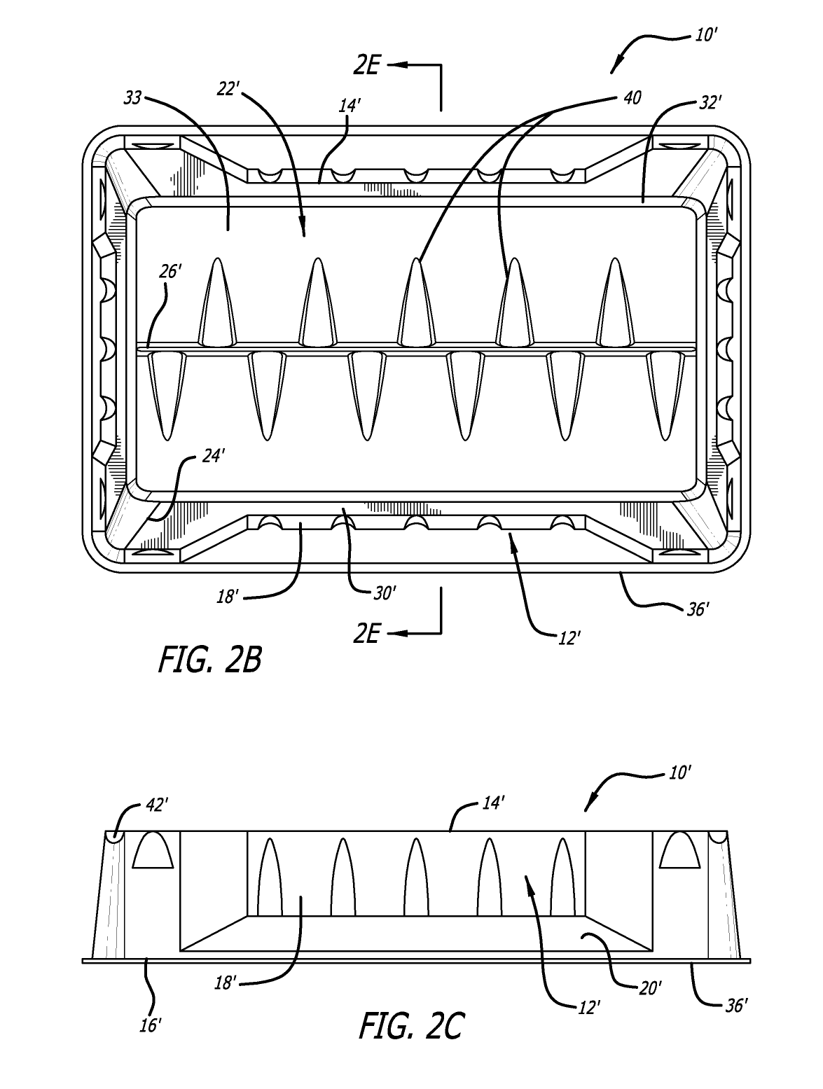

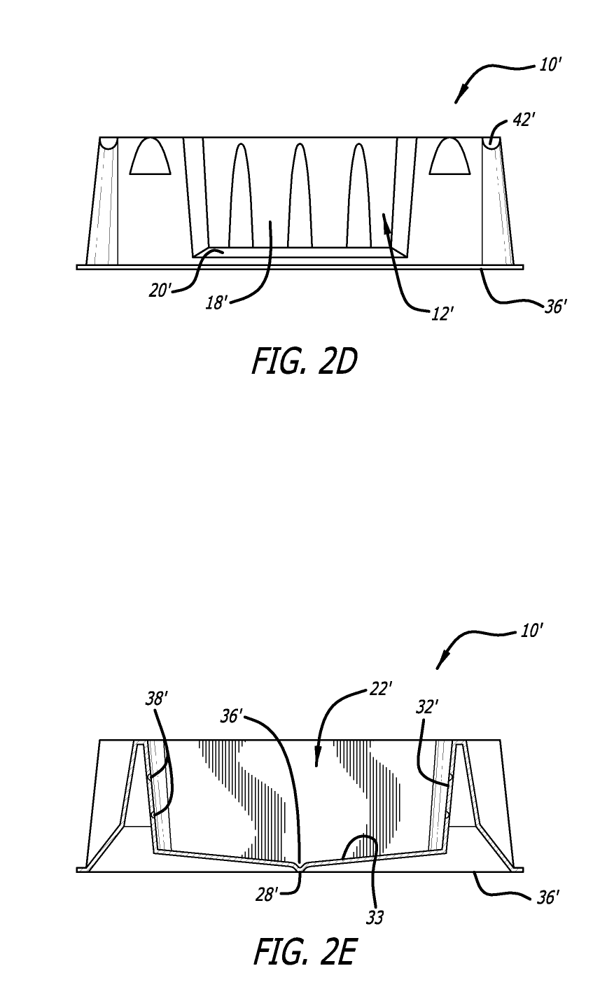

FIGS. 1A-1E and FIGS. 2A-2E illustrate various views of reagent reservoir fluid handling device embodiments described herein. The embodiments illustrated in FIGS. 1A-1E show a reagent reservoir embodiment, which can be configured to hold about 50 milliliters of liquid in certain instances. Embodiments illustrated in FIGS. 5A-5E show another reagent reservoir embodiment, which can be configured to hold about 100 milliliters of liquid in certain instances. Features common to the reagent reservoir illustrated in FIGS. 1A-1E and the reagent reservoir illustrated in FIGS. 5A-5E are denoted by identical reference numbers, where a prime symbol (′) refers to the common feature in FIGS. 2A-2E. Reagent reservoir 10, 10′, comprises sidewalls 12, 12′, trough 22, 22′, inner channel 26, 26′, and base surface 28, 28′. Reagent reservoirs described herein often comprise four sidewalls. In some embodiments, reagent reservoir sidewalls, 12, 12′ and trough 22, 22′ can comprise a polymer.

Each reagent reservoir sidewall 12, 12′, includes a top edge 14, 14′ and bottom edge 16, 16′. In some embodiments, sidewall top edge 14, 14′ can be coextensive with trough top edge 24, 24′. In certain embodiments, sidewall top edge 14, 14′ and trough top edge 24, 24′ may be connected by joining surface 30, 30′ (e.g., a substantially horizontal surface).

In some embodiments, sidewalls 12, 12′ may comprise substantially vertical surfaces 18, 18′. In certain embodiments, sidewalls 12, 12′ can comprise angled surfaces 20, 20′. In some embodiments, sidewalls 12, 12′ may comprise substantially vertical surfaces 18, 18′ that are coextensive with angled surfaces 20, 20′. In certain embodiments, sidewalls 12, 12′ may comprise angled surfaces 20, 20′ that are coextensive with other independently angled and/or curved surfaces.

Angled surfaces 20, 20′ in reagent reservoir embodiments described herein often can add structural rigidity and help distribute weight in a manner that enables the product to hold a volume of liquid many times the weight of the fluid handling device, without deforming or collapsing the reagent reservoir. Angled surfaces sometimes can be angled between about 1 degree to about 90 degrees with respect to a reference surface (e.g., a reference surface can be a horizontal service, a vertical surface or an angled surface). That is, angled surfaces sometimes can be angled about 1 degree, about 2 degrees, about 3, degrees, about 4 degrees, about 5 degrees, about 6 degrees, about 7 degrees, about 8 degrees, about 9 degrees, about 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, or about 90 degrees with respect to a reference surface.

Angled surfaces 20, 20′ sometimes can be used as a support element, as illustrated by sidewall flange 36, 36′. Sidewall flange 36, 36′ acts as a base surface or footing, to further support reagent reservoir 10, 10′. Sidewall flange 36, 36′ is angled with respect to sidewall base, or bottom edge 16, 16′. Sidewall flange 36, 36′ often is angled in the range of between about 85 to about 95 degrees with respect to sidewall base or bottom edge 16, 16′. That is, sidewall flange 36, 36′ can be angled about 85 degrees, 86 degrees, 87 degrees, 88 degrees, 89 degrees, 90 degrees, 91 degrees, 92 degrees, 93 degrees, 94 degrees, or about 95 degrees, with respect to sidewall base or bottom edge 16, 16′.

As noted above, reagent reservoir 10, 10′ can comprise a trough. The term “trough” as used herein refers to a long, shallow sometimes V-shaped receptacle for liquid. Trough 22, 22′ of reagent reservoir 10, 10′ often includes trough top edge 24, 24′. Reagent reservoir trough 22, 22′ can comprise angled surfaces 32, 32′ in some embodiments, and in certain embodiments reagent reservoir trough 22, 22′ can comprise substantially vertical surfaces 34, 34′. In some embodiments, reagent reservoir 10′ sometimes comprises a shallow angled surface 33 co-extensive with angled wall 32′. Shallow angled wall 33 sometimes forms the inner base surface of the trough in embodiments configured to hold larger volumes of reagents or liquids. The angled surfaces allow liquids to collect at a reagent reservoir low point. The combination of trough angled surface 32, 32′, gravity, and surface tension and/or surface adhesion properties of the polymer material, allows many liquids to completely and efficiently flow to the reservoir low point.

In some embodiments, a reagent reservoir trough 22, 22′ can include an inner channel 26, 26′. The inner channel 26, 26′ often is the reagent reservoir low point. In certain embodiments, reagent reservoir trough 22, 22′ can have trough base surface 28, 28′. Reagent reservoir trough 22, 22′ sometimes includes inner channel 26, 26′, which further comprises trough base surface 28, 28′, in some embodiments. In certain embodiments, trough surfaces (e.g., trough angled surface 32, 32′ and/or trough substantially vertical surface 34, 34′) can comprise volumetric graduations. In some embodiments, the volumetric graduations can be in 1 milliliter increments, 5 milliliter increments, 10 milliliter increments, 25 milliliter increments, or 50 milliliter increments, or combinations thereof.

Regent reservoirs described herein can be configured to hold any volume of liquid desired. Reagent reservoirs described herein often are configured to hold a suitable and convenient volume of liquid or reagent in the range of about 5 milliliters to about 250 milliliters. That is regent reservoirs described herein can be configured to hold about 5 milliliters, about 10 milliliters, about 25 milliliters, about 50 milliliters, about 100 milliliters, about 150 milliliters, about 200 milliliters, or about 250 milliliters.

In some embodiments, reagent reservoir trough 22, 22′ can be two or more troughs, each trough comprising a fractional portion of the volumetric capacity of the reagent reservoir. A reagent reservoir with a trough of certain dimension can hold a volume of liquid, such as 50 milliliters, for example. A reagent reservoir with identical dimension, where the trough is divided into 4 independent troughs, may still hold approximately 50 milliliters, but the volume in each division is divided into 4 smaller volumes. This allows one of skill in the art to use a single reagent reservoir to dispense a number of liquids, reagents or samples from the same fluid handling device, and in some cases using the same pipette tips. Reagent reservoirs described herein sometimes can have 2, 3, or 4 troughs, in certain embodiments.

In some embodiments, reagent reservoir sidewall bottom edge 16, 16′, and trough base surface 28, 28′ can be co-planar. In certain embodiments, the bottom surface of sidewall flange 36, 36′ and trough base surface 28, 28′ can be co-planar. The co-planar configuration of the reagent reservoir sidewalls and trough base surface can increase stability of the device, and can help minimize liquid splashing associated with the device flexing, deforming or movement. The central, lengthwise base support provided by the base surface (e.g., the under surface of the longitudinal inner channel) making contact with a working or supporting surface, can help distribute the weight of the liquid evenly which in turn can reduce or eliminate the tendency of the reagent reservoir to flex.

In certain embodiments, a reagent reservoir trough top edge 24, 24′ and a reagent reservoir sidewall top edge 14, 14′ can be coextensive, as illustrated in FIGS. 1A-1E and 2A-2E. As shown in the figures, the short sidewalls with a length in the range of about 3.37 inches exhibit a top edge that directly abuts or is coextensive with the top edge 24, 24′ of trough substantially vertical sidewall surface 18, 18′. That is, there is little or no substantially horizontal intervening surface between the trough vertical surface top edge and the top edge of the shorter sidewalls. In some embodiments, a reagent reservoir trough top edge 24, 24′ and a reagent reservoir sidewall top edge 14, 14′ may be connected by a joining surface 30, 30′, as illustrated in FIGS. 1A-1E and 2A-2E. As shown in the figures, the longer sidewalls with a length in the range of about 5.03 inches exhibit a top edge 14, 14′ that abuts, or is coextensive with, an intervening surface or joining surface 30, 30′, which in turn is coextensive with a top edge of trough 24, 24′. In certain embodiments, the intervening or joining surface often is substantially horizontal. In some embodiments, the top edge 14 of the longer sidewalls is coextensive with a top edge of trough 24, 24′.

In some embodiments, terminal edges, formed at (i) the junction of trough inner surface edges (e.g., 32, 32′, 34, and 34′) and sidewall top edges 14, 14′, and/or (ii) the junction of sidewall top edges 14, 14′ and substantially horizontal joining surfaces 30, 30′ may comprise cutouts or depressions 42, 42′. In certain embodiments, the cutouts or depressions can be used as a pouring spout to decant liquids or reagents. In some embodiments the cutouts or depressions may serve a structural function to provide structural rigidity or distribute material stresses formed in the polymer material during the thermoforming process.

Reagent reservoirs described herein sometimes also make use of additional features to provide structural rigidity, help distribute or isolate material stresses induced in the thermoforming process and to provide enhanced fluid flow surfaces in the reagent reservoir trough. In some embodiments, reagent reservoir embodiments 10, 10′ often comprise bossed and/or detent regions 38, 38′. In certain embodiments, reagent reservoir sidewalls 12, 12′ may be coextensive with bossed and/or detent regions 38, 38′. Bossed and/or detent regions 38, 38′ may act to isolate energy transfer to regions between the bossed or detent regions caused by accidental bumping of the fluid handling device, or flexing or stresses potentially caused by cooling, or warming of liquids held within the trough of reagent reservoir 10, 10′.

In some embodiments, reagent reservoir inner channel 26′ sometimes is coextensive with substantially perpendicular bosses and/or detent regions 40. In the embodiment illustrated in FIGS. 2A-2E, inner channel 26′ comprises substantially perpendicular detents 40. The detents may act as fluid collection channels that enhance the ability of fluid to flow to the lowest point in the trough. Without being limited to any particular theory, the additional curved surface area provided in the detent regions may aid the formation of drops or liquid streams which in turn can facilitate fluid flow and collection in the reagent reservoir inner channel 26′.

In certain embodiments, bossed and/or detent regions 38, 38′ often further comprise between about 1 and about 20 detent and/or bossed regions per sidewall and/or inner channel 26′/trough angled surface 32′. That is, reagent reservoir sidewalls 14, 14′, and/or reagent reservoir inner channel 26′, which often is coextensive with trough angled surface 32′, can comprise about 1 bossed and/or detent region, about 2 bossed and/or detent regions, about 3 bossed and/or detent regions, about 4 bossed and/or detent regions, about 5 bossed and/or detent regions, about 6 bossed and/or detent regions, about 7 bossed and/or detent regions, about 8 bossed and/or detent regions, about 9 bossed and/or detent regions, about 10 bossed and/or detent regions, about 11 bossed and/or detent regions, about 12 bossed and/or detent regions, about 13 bossed and/or detent regions, about 14 bossed and/or detent regions, about 15 bossed and/or detent regions, about 16 bossed and/or detent regions, about 17 bossed and/or detent regions, about 18 bossed and/or detent regions, about 19 bossed and/or detent regions, or about 20 bossed and/or detent regions per sidewall and/or inner channel/trough angled surface. A boss or detent can be of any convenient shape. In some embodiments, a boss and/or detent region can be a boss or detent in a shape independently chosen from a wedge, an arch (e.g., pointed arch, a trefoil arch, a drop arch, a keel or ogee arch also know as an ogive shape (e.g., pointed, curved surface) that often are configured as a secant ogive or elliptical ogive), a groove, a double concave surface, changing radius arches, changing radius grooves, and a pyramid, a V-shape and the like.

Reagent reservoirs described herein frequently are made with polymers and/or biodegradable polymers, in some embodiments. Reagent reservoirs described herein often are manufactured from materials described above, or other materials known in the art or yet to be formulated that have similar properties (e.g., biodegradable polymers), having a pre-manufacture thickness in the range of about 0.005 to about 0.050 inches. That is, reagent reservoirs described herein often are manufactured from materials, sometimes sheet materials and sometimes film materials, that have a pre-manufacture thickness of about 0.005 inches, about 0.010 inches, 0.015 inches, about 0.020 inches, about 0.025 inches, about 0.030 inches, about 0.035 inches, about 0.040 inches, about 0.045 inches or about 0.050 inches. The polymers frequently are subjected to a thermoforming process, which can deform sheets of polymer material in combination with heat, vacuum and/or pressurized air. The polymer material can be provided in sheets or in rolls in varying thicknesses. Polymer films generally have a thickness less than 0.01 inches, while polymer sheets typically have a thickness greater than 0.01 inches. Sheets or rolls of polymer material sometimes can include regions of varying thickness and/or regions of varying composition. The terms “polymer sheet” and “polymer film” can be used interchangeably when referring to polymer materials used in thermoforming processes, and when required will be distinguished by a material thickness. Thermoforming is discussed further below.

In certain embodiments, the post-manufacture, or post-thermoforming thickness of reagent reservoirs described herein is in the range of about 0.001 inches to about 0.050 inches. That is, reagent reservoirs described herein can have a post-manufacture or post-thermoforming thickness of about 0.001 inches, about 0.002 inches, about 0.003 inches, about 0.004 inches, about 0.005 inches, about 0.006 inches, about 0.007 inches, about 0.008 inches, about 0.009 inches, about 0.010 inches, 0.015 inches, about 0.020 inches, about 0.025 inches, about 0.030 inches, about 0.035 inches, about 0.040 inches, about 0.045 inches or about 0.050 inches. In some embodiments the reagent reservoirs described herein are manufactured with a uniform thickness. In certain embodiments, the reagent reservoirs described herein have different thicknesses in different parts of the reservoir.

In certain embodiments, the polymer in sidewalls 14, 14′ and trough 22, 22′ can be different, and in some embodiments the polymer in sidewalls 14, 14′ and trough 22, 22′ can be the same. In certain embodiments, reagent reservoirs described herein sometimes are made from biodegradable polymers chosen from the following categories or types of plastics; naturally-occurring polymers consisting of polysaccharides (e.g., starch and the like); microbial polyesters that can be degraded by the biological activities of microorganisms (e.g., polyhydroxyalkanoates and the like); conventional plastics mixed with degradation accelerators (e.g., mixtures having accelerated degradation characteristics such as photosensitizers); and chemosynthetic compounds (e.g., aliphatic polyesters and the like), Bio-PET, recycled Bio-PET, naturally photosensitive plastics and the like. A complete listing of the polymers suitable for use in embodiments described herein are presented above, and below in the examples.

Reagent Reservoir Methods of Use

The reagent reservoirs described herein often are used to manipulate or dispense liquids, reagents, or samples, in some embodiments. In certain embodiments, the reagent reservoirs described herein can be used in conjunction with other fluid handling devices to effect purification and/or isolation schemes. In certain embodiments, reagent reservoirs as described herein can be used in a method for manipulating a reagent, comprising: introducing a reagent to a reagent reservoir, and removing the reagent from the reagent reservoir; where the reagent reservoir comprises: sidewalls, each sidewall including a top edge and a bottom edge; and a trough including top edges, an inner channel and a base surface; where: the top edge of each sidewall is connected to a top edge of the trough, and the base surface of the trough and the bottom edge of each sidewall are co-planar. Frequently, liquid dispensing devices (e.g., manual or automated, single or multi-channel pipettors) can be used to introduce and/or remove reagents, liquids or samples to and/or from a reagent reservoir as described herein.

One of skill will be familiar with the operation of manual and/or automated liquid dispensing devices that can be utilized with reagent reservoirs described herein.

Reagent reservoirs described herein sometimes are used in conjunction with other fluid handling devices to enhance the uses of reagent reservoirs. The use of additional fluid handling devices can be incorporated into the general use methods described above. For example a solid support can be used with a reagent reservoir to remove nucleic acids above or below a threshold range, such that subsequent pipetting steps utilize a partially purified nucleic acid reagent. The partially purified nucleic acid reagent can be prepared by introducing a reagent to a reservoir that has an added or incorporated solid support, followed by (i) removal of the solid support, thereby leaving a partially purified liquid which can be removed to other containers, or (ii) removal of the liquid, thereby leaving a partially purified sample that can be reintroduced to a second liquid or reagent.

Pipette Tip Devices

Pipette tips typically are used to acquire, transport or dispense fluids in various laboratory settings. Pipette tips can be used in large quantities in both medical and research settings where handling of large numbers of biological samples is necessary. Pipette tips can be used manually, where an operator uses either a single channel pipette or a multichannel pipette (more than one dispensing outlet, typically available in 2, 4 or 8 channel configurations), or pipette tips can also be used in automated or robotic applications. In these automated or robotic applications, the robotic devices can be configured to also use 1, 2, 4, 8, 16, 24, 32, 40, 48, 56, 64, 72, 80, 88, 96, 384 or 1536 channel pipettes. Pipettes with 96 or more channels generally are used in microtiter plate or array/chip applications where high throughput analysis of a large number of samples is required, for instance, in laboratories or medical clinics where PCR, DNA chip technology, protein chip technology (chip technology is also known as arrays), immunological assays (ELISA, RIA), or other large number of samples must be processed in a timely manner. One example of an automated or robotic device used for high throughput analysis is a device referred to as the Oasis LM (produced by Telechem International, Inc. Sunnyvale Calif. 94089). This computer-driven biological workstation can be configured with up to 4 separate pipette tip heads with the ability to pipette 1, 8, 96, 384 or 1536 samples. The range of volumes is dependent on the particular head and pipette tip combination, and the volume range for the workstation is from 200 nanoliters to 1 milliliter. The workstation can operate all four pipette heads simultaneously.

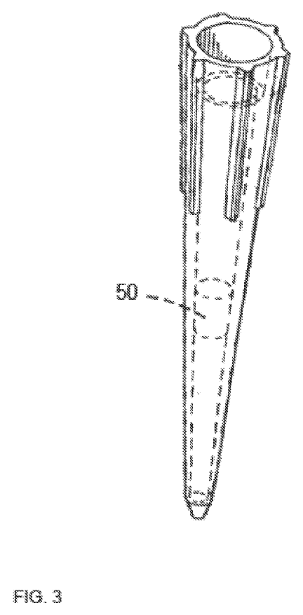

Pipette tips typically are available in sizes that hold from 0 to 10 microliters, 0 to 20 microliters, 1 to 100 microliters, 1 to 200 microliters and from 1 to 1000 microliters While the external appearance of pipette tips may be different, pipette tips suitable for use with the embodiments presented herein generally have a continuous tapered wall forming a central channel or tube that is roughly circular in horizontal cross section. However, any cross-sectional geometry can be used providing the resultant pipette tip device provides suitable flow characteristics, and can be fitted to a pipette. Pipette tips useable with embodiments described herein often taper from the widest point at the top-most portion of the pipette tip (pipette proximal end or end that fits onto pipette), to a narrow opening at the bottom most portion of the pipette tip (pipette distal or end used to acquire or dispel samples). In certain embodiments, a pipette tip wall can have two or more taper angles. While the inner surface of the pipette tip often forms a tapered continuous wall, the external wall may assume any appearance ranging from an identical continuous taper to a stepped taper or a combination of smooth taper with external protrusions. The upper-most outer surface of commonly available pipette tips often are designed to aid in pipette tip release by the presence of thicker walls or protrusions that interact with a pipette tip release mechanism found in many commercially available pipette devices. Additional advantages of the externally stepped taper are compatibility with pipette tip racks from different manufacturers. The thicker top-most portion of certain pipette tips also allows for additional rigidity and support such that additional pressure can be applied when pressing the pipette into the opening of the pipette tip to secure the pipette tip on the pipette, thus ensuring a suitable seal. The bore of the top-most portion of the central channel or tube will be large enough to accept the barrel of a pipette apparatus of appropriate size. As most pipette apparatus are capable of being used with universal pipette tips made by third party manufacturers, one of skill in the art would be aware of the different pipette tip sizes used with pipettes of different volumetric ranges. Therefore one of skill in the art appreciates that a pipette tip designed for use with a pipette used for handling samples of 1 to 10 microliters generally would not fit on a pipette designed for handling samples of up to 1000 microliters. The design and manufacture of standard pipettes and pipette tips is well known in the art, and injection molding techniques often are utilized. FIG. 3 illustrates a pipette tip embodiment as described herein.

The term “pipette tip device” as used herein refers to a pipette tip suitable for isolation, purification, concentration and/or fractionation of biological samples, where the device often is constructed of standard, commercially available pipette tips of any size or shape into which an insert can be inserted. The pipette tip housing often is manufactured from a polymer, which can be of any convenient polymer type or mixture for fluid handling (e.g., polypropylene, polystyrene, polyethylene, polycarbonate). A pipette tip device can be provided as a RNase, DNase, and/or protease free product, and can be provided with one or more filter barriers.

Filter barriers are useful for preventing or reducing the likelihood of contamination arising from liquid handling, and sometimes are located near the pipette tip terminus that engages a manual or robotic pipettor in certain embodiments.

A common concern in the use of pipette tips is that the pipettor may become contaminated by the sampled fluid. Contamination may pose health risks to the operators of the pipettor, who may become exposed to dangerous substances contained in the samples. Contamination will also damage the results of future sample testing if pipette tips subsequently used with the pipettor become contaminated. In applications such as DNA testing, where minute amounts of sample may replicate, such sample distortion is of concern.

Pipettor contamination most often results from contact between the pipettor and aerosol droplets of the fluid created during the acquisition, transfer and expulsion of the fluid sample. Contamination may also result from over-pipetting, in which too much suction is applied to the upper end of the pipette tip, drawing enough fluid into the pipette tip to contact the pipettor. To combat problems with contamination, in some embodiments, pipette tip devices include a filter plug between the upper and lower end of the pipette tip. In certain embodiments a filter as provided herein may be made from polyester, cork, plastic, silica, gels, or a combination thereof. In some embodiments a filter may be porous, non-porous, hydrophobic, hydrophilic or a combination thereof. In certain embodiments the filter may have antimicrobial properties (e.g., the filter may include, may be impregnated with, or may be coated with an antimicrobial material (e.g., antimicrobial metal; silver; gold, a resin comprising TRICLOSAN or chemical variant thereof mixed with polypropylene, polyethylene or polyethylene teraphthalate)).

In some embodiments, when a pipette tip with a filter is placed upon a pipettor, the filter and inner surface of the pipette tip may interstitially define a number of vertically-oriented pores such that the filter may seal against the inner surface of the pipette tip. The pores may be distributed according to a pore distribution which defines varying pore sizes within the filter dependent upon the volume defined by the inner surface of the pipette tip and the cross-sectional horizontal density of the filter material. The pore size of a filter may be of any size that aids in the function of the filter. In some embodiments, a filter as provided herein may have a maximum pore size be ten micrometers or less or three micrometers or less. In certain embodiments, a filter may have a pore size of about 10, 9, 8, 7, 6, 5, 4, 3, 2, 1, 0.5, or 0.05 micrometers.

In certain embodiments a degradable pipette tip device comprises a protective coating on its inner and outer wall surface. In some embodiments, a degradable pipette tip is about 15 to about 95 percent of a degradable material, or combination of degradable materials, by total device weight (e.g., about 20 to about 40, about 45 to about 65, about 50 to about 60, about 50 to about 80, about 50 to about 70, about 45 to about 55, about 30 to about 50, about 30 to about 40, about 50 to about 70, about 60 to about 80, about 60 to about 90, about 75 to about 95, about 40 to about 50, about 25 to about 50, about 25 to about 35, about 20 to about 40, about 20 to about 30, and about 15 to about 25 percent degradable material by total device weight).

Pipette Tip Racks

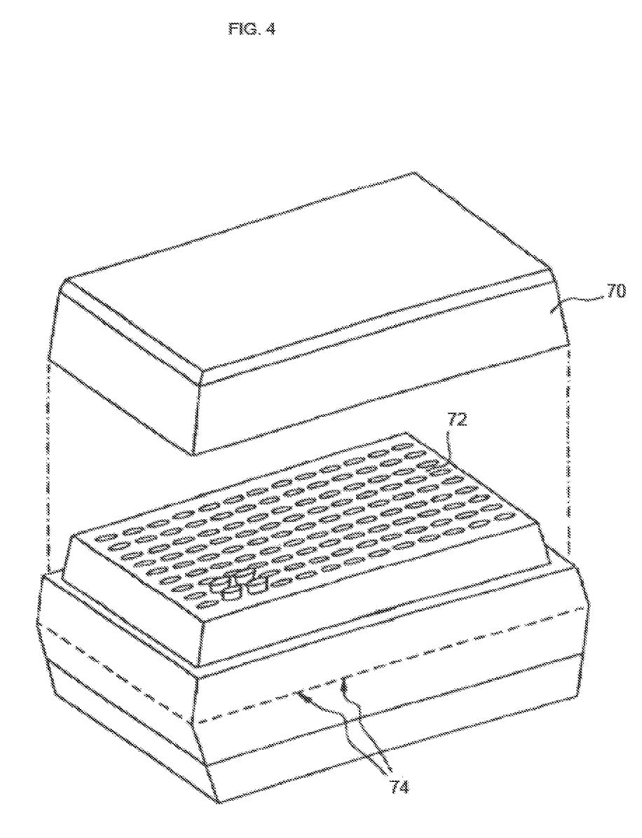

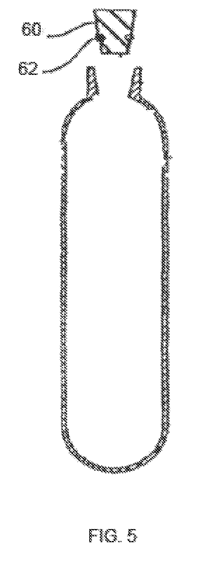

Tips for use with syringes and pipetting devices (e.g., pipette tips) typically are supplied in trays or holders, each tray often having openings for receiving 96 pipette tips. Typically, trays are packaged in an outer box which may have a bottom portion 74, FIG. 4, and a top/lid portion 70 and both the box and the trays are discarded when the tips have been used. The tip holders or trays 72 often come prepackaged with the tips already inserted, but there are also commercially available means of loading loose tips into tip holders. Alternatively, the tips can be manually placed into the holes of a tip holder. Once the tips are loaded into a tip holder, the tip holder is placed or snapped or secured into a support structure such as an outer box, and the tips, variably, with or without the tip holder, are released from the tip holder and box upon use. In certain embodiments, the tip holder and outer box are one unit or the tip holder and the bottom portion of the outer box are one portion.

A function of the outer box is to provide support during the tip removal process. Typically, the tips are removed when an instrument (e.g., manually or machine operated) that is inserted into the larger open top of the tip, and downward pressure is exerted, thus wedging the tip onto the instrument. The tip then is removed from the box, used and subsequently discarded. The top lid of the box may be made from a different material than the bottom of the box. For example, the top lid may be transparent so that the user can easily identify the top of the box and store it vertically.

The box acts to provide physical underlying support for this process, such that when downward pressure is exerted, the tip does not move downward or become misaligned with the instrument. The tip holder remains at the top of the box and assists by keeping the tips aligned in their respective holes. The tip holder alone does not provide sufficient support, however, because the tip holder is often a fairly thin and flexible tray that is not a free standing independent support mechanism. An outer box for the tip holders is thus required.

It has been observed that when a user is removing a tip from a tip holder, the tip holder may be inadvertently lifted relative to the support structure so that it requires repositioning before use is resumed. Such inadvertent lifting may occur, for example, when a tip or a row of tips is being removed at an angle other than perpendicular to the tip support. When the tip holder is so lifted, typically the user must handle the system to reposition the tip holder and any displaced tips. It is therefore desirable to provide a pipette tip holder and box support structure which are antimicrobial in nature and prevent microbial contamination of the pipette tips as the tips are removed. In some embodiments of a pipette tip rack device as provided herein, materials that has either or both an antimicrobial and/or a photosensitizer effect such as a metal or metal compound may coat the exposed surfaces of the tip holder and outer box or those surfaces in contact with the pipette tips or any portions that may be manually handled or portions thereof as shown in FIG. 4 or may be comprised within all components of the device itself, such as the tip holder.

In certain embodiments the biodegradable pipette tip rack device comprises a protective coating on all or some or all of its parts (e.g., the top and bottom of the tip holder, the inner and outer surface of the inner and outer box portion). In certain embodiments, all or some of the parts of the rack are about 15 to about 95 percent of a degradable material, or combination of degradable materials, by total device weight (e.g., about 20 to about 40, about 45 to about 65, about 50 to about 60, about 50 to about 80, about 50 to about 70, about 45 to about 55, about 30 to about 50, about 30 to about 40, about 50 to about 70, about 60 to about 80, about 60 to about 90, about 75 to about 95, about 40 to about 50, about 25 to about 50, about 25 to about 35, about 20 to about 40, about 20 to about 30, and about 15 to about 25 percent degradable material by total device weight).

Other Biodegradable Laboratory Fluid Handling Devices

Many laboratory or clinical procedures require collecting, manipulating, preparing, handling, or fractionating samples in tubes or containers of differing sizes. Such devices can include laboratory fluid handling tubes (see FIG. 5, for example), microtiter plates, pipette tip filters, centrifuge tubes and caps, laboratory vials, specimen containers, petri dishes, capillary tubes, reagent reservoirs, syringes, blister packs, microfluidic devices and beads and/or particles that can associate with biomolecules under certain conditions. In certain embodiments any of these devices or similar types of devices can be manufactured using the methods presented herein. Microcentrifuge tubes (e.g., EPPENDORF tubes) often are utilized due to their availability in convenient sizes (250 microliter tubes, 500 microliter tubes, 1.5 milliliter tubes and 2 milliliter tubes), their sturdy design (capable of withstanding centrifugation, heating, cooling to temperatures below −70 degrees C., resistance to many solvents and chemicals) and availability as RNase and DNase free products with low liquid retention. These tubes also are available in configurations which have a locking lid affixed to the tube body by a hinge co-extensive from the tube body, or with a standard screw cap top. The tubes also are available in various colors and with specialized surfaces on the outside of the tube for labeling. While these tubes have gained acceptance and use as a preferred laboratory liquid handling tube, the usefulness of these tubes can be limited to volumes of 2 milliliters or less. Many laboratories and medical clinics also have a requirement for collecting, storing and/or processing samples greater than 2 milliliters in size or samples that may contain solids. In these instances specimen containers are used. Specimen containers are typically made from the same materials used for microcentrifuge tubes and so have many of the same advantageous properties. Typically these tubes have either a screw cap top, or a lid that that snaps securely in place to the body of the specimen container to provide a leak resistant or leak proof seal. The lids can be made of the same or a different material as the body. The specimen containers can have a tapered body or a non-tapered body. They have the additional added benefit of being able to handle liquid, solid or a combination of liquid and solid samples of larger sizes.

Specimen containers (also sometimes referred to as specimen cups) are also available in a variety of sizes (about 15 milliliters, 20 milliliters, 4 ounces (about 125 milliliters), 4.5 ounces, 5 ounces, 7 ounces, 8 ounces (about 250 milliliters) and 9 ounces), allowing collection, storage, and/or processing of samples of over 300 milliliters. One of skill in the art understands that new products which perform the equivalent function and products of differing sizes are developed continuously. Therefore one of skill in the art will understand that containers not listed herein, but equivalent in function and of possibly different sizes are envisioned as being equivalent and therefore usable in the embodiments described herein. Laboratory liquid handling devices, such as reagent reservoirs for example, may be utilized to contain a biological sample (e.g., urine, semen, blood, plasma, sputum, feces, mucous, vaginal fluid, spinal fluid, brain fluid, tears cells and the like), a liquid reagent, or a mixture thereof.

Microtiter plates, and such similar devices, can be used for examination of the physical, chemical or biological characteristics of a quantity of samples in parallel. The samples to be examined are arranged in matrix form in small cavities or wells. Microtiter plates are known, for example, from U.S. Pat. No. 5,457,527, WO 97/22754 and WO 95/03538. They comprise a specimen plate, or cavity plate, and a bottom plate, where the bottom plate is made of plastic or glass. The bottom plate and cavity plate are joined together in such a way that the bottom plate closes the wells of the cavity plate at the bottom. The bottom plate can be transparent and the plate is suitable in being made from biodegradable material within the scope of the present technology.

Microtiter plates are generally used in order to divide each sample into many portions and then to react the resulting sample portions with many reagents of different kinds respectively so that the same sample can be tested with respect to many items. As an alternative, it is also required to react many samples with the same reagent so that the same test can be performed on such many samples. In some embodiments, a microtiter plate is made of a transparent material and defines a number of round-bottomed reaction wells equipped with openings. Each of the reaction wells may be adapted as a reaction vessel. Plates can have any number of wells such as for example 6, 12, 24, 96, 384, 1536, 3456, 9600 and the like. Each well can hold any amount of liquid such as, for example, 0.001-0.01 ml, 0.01-0.1 ml, 0.1-1.0 ml, 1.0-10.0 ml, 10.0-100.0 ml, 100.0-1,000 ml and the like.

Laboratory liquid handling tubes, microtiter plates, specimen containers, reagent reservoirs, and blister packs, are manufactured from a variety of components and can easily incorporate biodegradable materials. Common materials used for the manufacture of these types of tubes and containers are polypropylene, polyethylene, and polycarbonate. Other thermoplastics or polymers may also be used. Many of the commercially available tubes and containers come pre-sterilized or with guarantees of being RNase, DNase, and protease free. For the purpose of these embodiments, any material that has good chemical or solvent resistance, has low liquid retention (i.e., made of hydrophobic materials or coated to be hydrophobic), is safe for the handling of biological materials (RNase, DNase, and protease free), that can withstand heating and extreme cooling and that is biodegradable within the scope of the present technology is suitable for use.

The laboratory liquid handling tube or container devices can be used in a variety of manners. In the case of whole cells or intact tissue, the tubes can be used to perform cell lysis followed by the isolation, purification, concentration and/or fractionation of a biological molecule of interest in a single step. Cell lysis procedures and reagents are commonly known in the art and may generally be performed by chemical, physical, or electrolytic lysis methods. For example, chemical methods generally employ lysing agents to disrupt the cells and extract the nucleic acids from the cells, followed by treatment with chaotropic salts. Physical methods such as freeze/thaw followed by grinding, the use of cell presses and the like are also useful if intact proteins are desired. High salt lysis procedures are also commonly used. These procedures can be found in Current Protocols in Molecular Biology, John Wiley & Sons, N.Y., 6.3.1-6.3.6 (1989), incorporated herein in its entirety. Following cell lysis using methods not requiring high salt, the biological material of interest can be directly eluted from the insert. For high salt lysis, it may be necessary to dilute the sample into a larger volume to affect binding of the biological material of interest, prior to sample isolation. Alternatively, increasing salt concentration may be required to elute the biological material of interest from the insert. Once the appropriate volume and salt concentration of sample are achieved, the tubes or containers can be gently agitated to ensure maximal binding, followed by elution in a minimal volume of elution buffer. The concentrations and volumes of buffers will be dependent on the species of molecule of interest and the volume of starting material on which lysis was performed.

FIG. 5 shows a vertical cross-sectional view of a biodegradable centrifuge tube and cap embodiment. The cap 60 may be a plug with seal 62 as depicted in FIG. 5 or may be a screw top or any other type of cap that seals the tube.

In certain embodiments biodegradable fluid handling tubes, microtiter plates, pipette tip filters, centrifuge tubes and caps, laboratory vials, specimen containers, petri dishes, capillary tubes, reagent reservoirs, syringes, blister packs, microfluidic devices and beads and/or particles that can associate with biomolecules under certain conditions comprise a protective coating on some or all parts that may be exposed to liquid, such as the inner and outer portions, for example. In some embodiments, some or all of the parts are about 15 to about 95 percent of a degradable material, or combination of degradable materials, by total device weight (e.g., about 20 to about 40, about 45 to about 65, about 50 to about 60, about 50 to about 80, about 50 to about 70, about 45 to about 55, about 30 to about 50, about 30 to about 40, about 50 to about 70, about 60 to about 80, about 60 to about 90, about 75 to about 95, about 40 to about 50, about 25 to about 50, about 25 to about 35, about 20 to about 40, about 20 to about 30, and about 15 to about 25 percent degradable material by total device weight).

### Degradable Fluid Handling Device Manufacturing Processes

Degradable fluid handling devices described herein can be manufactured using any manufacturing process suitable for use with plastics or polymers with the proviso the manufacturing process does not adversely effect the degradable aspect of the plastic or polymer. Non-limiting examples of processes suitable for manufacture of degradable fluid handling devices and degradable plastic-wares include extrusion, molding, injection molding, thermoforming, casting, combinations thereof and the like.

Thermoforming is a manufacturing process whereby a plastic sheet is heated, between infrared, natural gas, or other heaters, to a pliable forming temperature, formed to a specific shape in a mold, and trimmed to create a usable product. The sheet, or “film” when referring to thinner gauges and certain material types, is heated to a high-enough temperature that it can be stretched into or onto a mold and cooled to a finished shape. In the highest expression of the technology, thermoforming offers close tolerances, tight specifications, and sharp detail. When combined with advanced finishing techniques, high-technology thermoforming results in products comparable to those formed by injection molding. There are several categories of thermoforming, including vacuum forming, pressure forming, twin-sheet forming, drape forming, free blowing, and simple sheet bending.

In a common method of high-volume, continuous thermoforming of thin-gauge products, plastic sheet is fed from a roll or from an extruder into a set of indexing chains that incorporate pins, or spikes, that pierce the sheet and transport it through an oven for heating to forming temperature. Alternatively, the plastic sheet sometimes can be held or clamped into a frame-like holding device, which is then transported into the heating area (e.g., oven or kiln and the like). The heated sheet is then transported into a form station where a mating mold and pressure-box close on the sheet, with vacuum then applied to remove trapped air and to pull the material into or onto the mold along with pressurized air to form the plastic to the detailed shape of the mold. Plug-assists are typically used in addition to vacuum in the case of taller, deeper-draw formed parts in order to provide the needed material distribution and thicknesses in the finished parts. After a short form cycle, a burst of reverse air pressure is actuated from the vacuum side of the mold as the form tooling opens, commonly referred to as air-eject, to break the vacuum and assist the formed parts off of, or out of, the mold. A stripper plate may also be utilized on the mold as it opens for ejection of more detailed parts or those with negative-draft, undercut areas. The sheet containing the formed parts then indexes into a trim station on the same machine, where a die cuts the parts from the remaining sheet web, or indexes into a separate trim press where the formed parts are trimmed. One of skill in the art will be aware of modifications to the described thermoforming process, or other thermoforming methods that can be used to produce equivalent fluid handling devices.

Thermoforming processes generally can be used to produce products from thin gauge (sheet thicknesses less than 0.060 inches, for example) or thick gauge (sheet thicknesses greater than 0.120 inches, for example) plastic sheet. An “intermediate” thickness market, for products with a thickness that falls between 0.060 and 0.120, is currently undergoing rapid growth. Products made by thermoforming range from thin gauge product packaging and laboratory supplies to thick gauge aircraft windscreens, automobile dashboards, automobile body panels and the like. Thermoforming often offers advantages to other types of plastic forming, including but not limited to, shorter time from design to market, lower tooling costs, higher achievable tolerances, lower temperature and energy requirements with respect to injection molding and the like.

Differences in sheet thickness and polymer material will define the temperature and length of time that the plastic is heated. The plastic material typically is heated until it becomes pliable, but does not melt. One method for determining the proper temperature of the plastic to be molded is to visually or electronically identify a sag in the center of the polymer sheet, clamped for processing. The plastic sheet sometimes is held in a frame-like device while heating, to allow the pliable plastic to be contacted with the mold. The temperature at which a plastic begins to sag, is defined as the “sag point” or “sag temperature”. The pliable material begins to “bend” or “bow” downwards, sometimes aided by gravity, into the mold. In some embodiments, pressurized air can be blown at the pliable sheeting to form a larger sag depression or, if the air is blown upwards, a pressure induced “bubble” (e.g., pressure bubble), for the purposes of thinning the sheet in the central region prior to contact with the mold.

Any suitable thermoforming process can be used to produce the reagent reservoirs described herein. Depending on the type of thermoforming process used (e.g., vacuum forming, pressure forming, plug-assist forming, reverse-draw forming, free forming or matched-die forming), vacuum, pressurized air, plugs or combinations thereof force the pliable plastic into the mold. A vacuum can be applied to one side of the mold, and in some embodiments pressurized air from the other side of the mold can help further evacuate air on the negative pressure side and/or further force the heated plastic against the mold. In some embodiments a plug also can be used to force the heated plastic against the molding surface. Upon cooling, the thermoformed product can be released from the mold by pressurized air, or a stripping device. Final trimming and processing steps yields the final thermoformed product.

Vacuum forming and pressure forming are substantially similar processes with the exception of the air pressure used. In vacuum forming, air is evacuated from beneath the polymer material as it being placed on the mold. The vacuum formed beneath the polymer as it is placed in contact with the mold aids in stretching, and seating, the heated polymer into all the mold surfaces. The vacuum formed beneath the polymer, allows atmospheric pressure above the polymer to act in combination with the suction below the polymer to force the polymer on the mold. The vacuum is released when the plastic has cooled. In some processes, pressurized air can be used to release the product from the mold surface, the air being blown up at the product through the same vents used to evacuate the air from beneath the polymer. In certain processes, a mechanical stripper is used to release the product from the mold.

Pressure forming utilizes pressurized air, blown on the heated polymer, to aid in stretching and seating the heated polymer on the mold. A high pressure blast of air is applied quickly to the heated polymer to force the polymer against the mold. Pressure forming offers the advantages of; lower temperatures (e.g., polymer need not be as pliant, due to the high pressure air used to force the polymer into the mold), faster cycle times (e.g., less time to cool and less time to seat in mold), and better dimensional control (e.g., uniformity of thickness due to lower temperatures and less stretching). Pressure forming methods often are carried out in combination with vacuum forming and/or plug-assist forming. Pressurized air and mechanical strippers commonly are used to remove product from a molding surface in many thermoforming processes.

Plug-assist forming often is a combinatorial method used in conjunction with another method of thermoforming. Non-limiting examples of plug-assist forming include, pressure bubble plug assist forming, vacuum aided plug assist forming, and pressure aided plug assist forming. The heated polymer is partially forced into the mold using a plug. The polymer is further seated onto the mold by vacuum or pressurized air. Plugs typically are about 10% to 20% smaller in length and width than the mold. In some embodiments, the plug can include one or more features or contours found in the final product. Plugs can be made from a variety of materials with low heat conductivity and high dimensional stability (e.g., necessary in pressure assist or vacuum assist forming methods). Plug-assist forming generally offers better wall thickness uniformity than vacuum or pressure forming.

Reverse-draw thermoforming often is utilized when products with deep draws are required. The term “draw” as used with reference to thermoforming refers to a feature (e.g., well, wall, trough and the like) with a significant depth. A non-limiting example of an object with a deep draw, relative to the overall height of the object is a microtiter plate. Each well of a microtiter plate has a well wall height that is substantially the same as the overall height of the object. Forming an object with many features that have a deep draw often requires reverse-draw forming or reverse-draw forming in combination with another method (e.g., plug-assist, plug-assist and vacuum assist, combinations thereof, and the like). The reverse-draw method utilizes the “bubble” process mentioned above. The polymer sheet is heated, thinned using pressurized air, forced into the mold using vacuum, plug-assist, pressurized air or combinations thereof, and fine, detail features often necessary in products with deep draws are created.

Matched die forming is another process often used for products with fine detail. The material is heated and pressed between two matching molds. No vacuum or air pressure is applied during the forming process. The material is kept under pressure in the matching molds until completely cooled, thereby producing the desired product. Matched die forming offers increased uniformity in stretching and/or thinning of the formed features.

In certain embodiments, reagent reservoirs described herein can be prepared by a process that comprises contacting a mold with a polymer sheet; and deforming the sheet on the mold, whereby a reagent reservoir is formed from the sheet; where the reagent reservoir comprises: sidewalls, each sidewall including a top edge and a bottom edge; and a trough including top edges, an inner channel and a base surface; where the top edge of each sidewall is connected to a top edge of the trough, and the base surface of the trough and the bottom edge of each sidewall are co-planar. In some embodiments, a process for preparing reagent reservoirs described herein comprises: contacting a mold with a polymer sheet; and deforming the sheet on the mold, whereby a reagent reservoir is formed from the sheet where the reagent reservoir comprises: sidewalls, each sidewall including a top edge and a bottom edge; and a trough including top edges, an inner channel and a base surface; where the top edge of each sidewall is connected to a top edge of the trough, and the base surface of the trough and the bottom edge of each sidewall are co-planar.

The features formed in the thermoformed polymer sheet are generated by contacting a heated polymer sheet with a mold comprising the desired three dimensional features. Molds can be made from a variety of materials including, but not limited to, machined aluminum, cast aluminum, composite materials and the like, for example. In some embodiments, the mold has surfaces that form three-dimensional surfaces of the reagent reservoir from the sheet. Molds sometimes are negative molds (e.g., concave cavity) and sometimes are positive molds (e.g., convex shape). For products made using a negative mold, the exterior surface has the exact surface contour of the mold cavity. The inside surface often is an approximation of the contour and possesses a finish corresponding to that of the starting sheet. By contrast, for products made using a positive mold, the interior surface features are substantially identical to that of the convex mold; and its outside surface is an approximation. The use of positive or negative molds can be an important consideration in thermoforming due to the differences in material stretching and thinning achieved with each mold type. In matched die forming, a positive and a negative mold are used, thereby producing products with surface contours and finish detail that is identical to both mold pieces.

In certain embodiments, the sheet often is contacted with a mold via vacuum, and/or pressurized air. In some embodiments, the sheet can be contacted with a mold in the absence of applied vacuum or air pressure. In some embodiments, the mold and/or environment around the mold may be at a reduced temperature, relative to the temperature of the heated polymer material, to promote rapid, efficient cooling of the formed products. The temperature to which the polymer material is heated is dependent on the chemical composition and thickness of the polymer, but typically is in a range around the sag point determined for that combination of polymer composition and sheet thickness. A temperature that can be suitable for deforming a polymer sometimes is in a range of between about 120 degrees Celsius (C) and about 150 degrees C., between about 120 degrees C. and about 160 degrees C., between about 120 degrees C. and about 170 degrees C., between about 120 degrees C. and about 180 degrees C., between about 120 degrees C. and about 190 degrees C., between about 120 degrees C. and about 200 degrees C., between about 120 degrees C. and about 210 degrees C., between about 120 degrees C. and about 220 degrees C. or between about 110 degrees C. and about 230 degrees C. (e.g., about 110 degrees C., about 120 degrees C., about 130 degrees C., about 140 degrees C., about 150 degrees C., about 160 degrees C., about 170 degrees C., about 180 degrees C., about 190 degrees C., about 200 degrees C., about 210 degrees C., about 220 degrees C., and about 230 degrees C.).

Extrusion is a process used to generate objects of a fixed cross-sectional profile. A material is pushed or drawn through a die of the desired cross-section. Two advantages of extrusion processes over other manufacturing processes is the ability to generate complex cross-sections and work materials that are brittle, because the material encounters only compressive and shear stresses. Such processes can be utilized to form finished parts with an excellent surface finish. Extrusion may be continuous (e.g., theoretically producing indefinitely long material) or semi-continuous (e.g., producing many pieces). Extrusion processes can be performed with material in hot or cold form.

Molding is a process of manufacture that shapes pliable raw material using a rigid frame or model called a mold. A mold often is a hollowed-out block filled with a liquid, including, without limitation, plastic, glass, metal, or ceramic raw materials. The liquid hardens or sets inside the mold, adopting its shape. A release agent sometimes is used to facilitate removal of the hardened or set substance from the mold.

Injection molding is a manufacturing process for producing objects (e.g., pipette tips, for example) from thermoplastic materials (e.g., nylon, polypropylene, polyethylene, polystyrene and the like, for example), thermosetting plastic materials (e.g., epoxy and phenolics, for example) and degradable plastics and polymers described herein. The plastic material of choice often is fed into a heated barrel, mixed, and forced into a mold cavity where it cools and hardens to the configuration of the mold cavity. The melted material sometimes is forced or injected into the mold cavity, through openings (e.g., a sprue), under pressure. A pressure injection method ensures the complete filling of the mold with the melted plastic. After the mold cools, the mold portions are separated, and the molded object is ejected. In some embodiments, additional additives can be included in the plastic or heated barrel to impart the additional properties to the final product (e.g., anti-microbial, or anti-static properties, for example).

The mold is configured to hold molten plastic in the correct geometry to yield the desired product upon cooling of the plastic. Injection molds sometimes are made of two or more parts, and can comprise a core pin. A core pin sometimes can determine the thickness of the object wall, as the distance between the core pin and the outer mold portion is the wall thickness. Molds typically are designed so that the molded part reliably remains on the core pin when the mold opens, after cooling. A core pin sometimes can be referred to as the ejector side of the mold. The part can then fall freely away from the mold when ejected from the core pin, or ejector side of the mold.

Casting is a manufacturing process by which a liquid material generally is flowed into a mold, which contains a hollow cavity of the desired shape, and then the liquid material is allowed to solidify. The solid casting is then ejected or broken out to complete the process. Casting may be used to form hot liquid metals or various materials that cold set after mixing of components (such as epoxies, concrete, plaster and clay). Casting is most often used for making complex shapes that would be otherwise difficult or uneconomical to make by other methods. Casting often is subdivided into two distinct subgroups: expendable and non-expendable mold casting. Expendable mold casting is a generic classification that includes sand, plastic, shell, plaster, and investment (lost-wax technique) moldings. This method of mold casting involves the use of temporary, non-reusable molds. Non-expendable mold casting differs from expendable processes in that the mold need not be reformed after each production cycle. This technique includes at least four different methods: permanent, die, centrifugal, and continuous casting.

### EXAMPLES

Described hereafter are non-limiting examples of embodiments of the technology.
A1. A polymer fluid handling device comprising a biodegradable plastic in an amount that results in about 60 to 90 percent decomposition within about 60 to 180 days of being placed in a composting environment.
A2. The polymer fluid handling device of embodiment A1, wherein the device is selected from the group consisting of a pipette tip, pipette tip rack, microtiter plate, reagent reservoir, centrifuge tube, centrifuge tube cap, syringe, petri dish, and vial.
A3. The polymer fluid handling device of embodiment A1, wherein the biodegradable plastic is selected from the group consisting of a natural polymer, a bacterial produced cellulose, and chemically synthesized polymeric materials.
A4. The polymer fluid handling device of embodiment A3, wherein the biodegradable natural polymer plastic further comprises a plasticizer, resin, filler, and/or rheology modifying agents.
A5. The polymer fluid handling device of embodiment A3, wherein the chemically synthesized polymeric material is selected from the group consisting of an aliphatic polyester, an aliphatic-aromatic polyester and a sulfonated aliphatic-aromatic polyester.
A6. The polymer fluid handling device of embodiment A3, wherein the biodegradable plastic is photodegradable and further comprises a photosensitizer.
A7. The polymer fluid handling device of embodiment A6, wherein the photo-biodegradable plastic further comprises iron, zinc, cerium cobalt, chromium, copper, vanadium and/or manganese compounds.
A8. The polymer fluid handling device of embodiment A3, wherein the biodegradable plastic further comprises colorants, stabilizers, antioxidants, deodorizers, flame retardants, lubricants, mold release agents or combinations thereof.
A9. The polymer fluid handling device of embodiment A3, wherein the biodegradable plastic further comprises polyhydroxy-containing carboxylate, such as polyethylene glycol stearate, sorbitol palmitate, adduct of sorbitol anhydride laurate with ethylene oxide and the like; epoxidized soybean oil, oleic acid, stearic acid, and epoxy acetyl castor oil or combinations thereof.
A10. The polymer fluid handling device of embodiment A3, wherein the biodegradable plastic further comprises maleic anhydride, methacrylic anhydride or maleimide
A11. The polymer fluid handling device of embodiment A3, wherein the biodegradable plastic comprises a polymer attacking agent such as a microorganism or an enzyme.
A12. The polymer fluid handling device of embodiment A3, wherein the device comprises a coating layer, that prevents passage of gas or permeation of water, on any surface that comes into contact with a liquid.
A13. The polymer fluid handling device of embodiment A12, wherein the device uses a coating layer consisting of silicon, oxygen, carbon, hydrogen, edible oils, drying oils, melamine, phenolic resins, polyester resins, epoxy resins, terpene resins, urea-formaldehyde reins, styrene polymers, polyvinyl chloride, polyvinyl alcohol, polyvinyl acetate, polyacrylates, polyamides, hydroxypropylmethylcellulose, methocel, polyethylene glycol, acrylics, acrylic copolymers, polyurethane, polylactic acid, polyhydroxybutyrate-hydroxyvalerate copolymers, starches, soybean protein, waxes, and mixtures thereof.
A14. The polymer fluid handling device of embodiment A3, wherein the biodegradable plastic further comprises Bio-PET.
A15. A polymer fluid handling device comprising:
a biodegradable plastic in an amount that results in about 60 to 90 percent decomposition within 60 to 180 days of being placed in a composting environment; and
is about 40 to about 70 percent starch by total device weight.
B1. A reagent reservoir, comprising:
   sidewalls each including a top edge and bottom edge; and
   a trough including top edges, an inner channel and a base surface; wherein:
      the top edge of each sidewall is connected to a top edge of the trough;
      the base surface of the trough and the bottom edge of each sidewall are co-planar; and
      the sidewalls and the trough comprise a polymer.
C1. A reagent reservoir prepared by a process comprising:
   contacting a mold with a polymer sheet; and
   deforming the sheet on the mold, whereby a reagent reservoir is formed from the sheet; wherein the reagent reservoir comprises:
   sidewalls each including a top edge and bottom edge; and
   a trough including top edges, an inner channel and a base surface; wherein:
   the top edge of each sidewall is connected to a top edge of the trough; and
   the base surface of the trough and the bottom edge of each sidewall are co-planar.
D1. A process for preparing a reagent reservoir, comprising:
   contacting a mold with a polymer sheet; and
   deforming the sheet on the mold, whereby a reagent reservoir is formed from the sheet; wherein the reagent reservoir comprises:
   sidewalls each including a top edge and bottom edge; and
   a trough including top edges, an inner channel and a base surface; wherein:
   the top edge of each sidewall is connected to a top edge of the trough; and
   the base surface of the trough and the bottom edge of each sidewall are co-planar.
E1. A method for manipulating a reagent in a reagent reservoir, comprising:
   introducing a reagent to a reagent reservoir; and
   removing the reagent from the reagent reservoir; wherein the reagent reservoir comprises:
   sidewalls each including a top edge and bottom edge; and
   a trough including top edges, an inner channel and a base surface; wherein:
      the top edge of each sidewall is connected to a top edge of the trough; and
      the base surface of the trough and the bottom edge of each sidewall are co-planar.
F1. The reagent reservoir of any one of embodiments B1-E1, wherein the trough comprises an angled surface.
F2. The reagent reservoir of any one of embodiments B1-F1, wherein the sidewalls comprise an angled surface.
F3. The reagent reservoir of any one of embodiments B1-F2, wherein the sidewalls comprise a substantially vertical surface.
F4. The reagent reservoir of any one of embodiments B1-F3, further comprising four sidewalls.
F5. The reagent reservoir of any one of embodiments B1-F4, wherein the trough comprises an inner channel which further comprises a base surface.
F6. The reagent reservoir of any one of embodiments B1-F5, wherein the trough surfaces can comprise volumetric graduations.
F7. The reagent reservoir of any one of embodiments B1-F6, wherein the trough is two or more troughs.
F8. The reagent reservoir of any one of embodiments B1-F7, wherein an edge of the trough and an edge of the sidewalls is coextensive.
F9. The reagent reservoir of any one of embodiments B1-F8, wherein an edge of the trough and an edge of a sidewall are connected by a joining surface.
F10. The reagent reservoir of embodiment F9, wherein the joining surface is substantially horizontal surface.
F11. The reagent reservoir of any one of embodiments B1-F10, wherein terminal edges, formed at (i) the junction of trough inner surface edges and sidewall edges, and/or (ii) the junction of sidewall edges and substantially horizontal joining surfaces, comprise cutouts or depressions.
F12. The reagent reservoir of any one of embodiments B1-F11, wherein the sidewalls comprise a flange, angled with respect to the base of the substantially vertical sidewall.
F13. The reagent reservoir of embodiment F12, wherein the flange is angled at about 90 degrees with respect to the base of the substantially vertical sidewall.
F14. The reagent reservoir of any one of embodiments B1-F13, wherein a trough base surface is coplanar with a sidewall bottom edge and/or a sidewall flange bottom or lower surface.
F15. The reagent reservoir of any one of embodiments B1-F14, wherein the sidewalls are coextensive with bossed and/or detent regions.
F16. The reagent reservoir of any one of embodiments B1-F15, wherein the trough inner channel is coextensive with substantially perpendicular bossed and/or detent regions.
F17. The reagent reservoir of any one of embodiments B1-F16, wherein the bossed and/or detent regions comprise between about 1 and about 20 bossed and/or detent regions per sidewall and/or channel.
F18. The reagent reservoir of any one of embodiments B1-F17, wherein the bossed and/or detent regions are embossed or detent in a shape chosen from, a wedge, an arch an ogive shape (e.g., pointed, curved surface), a groove, a double concave surface, changing radius arches, changing radius grooves, a pyramid, a V-shape and the like.
F19. The reagent reservoir of any one of embodiments B1-F18, wherein the sidewalls and trough comprise different polymers.
F20. The reagent reservoir of any one of embodiments B1-F19, wherein the sidewalls and trough comprise the same polymer.
F21. The reagent reservoir of any one of embodiments B1-F20, wherein the polymer is a biodegradable polymer chosen from naturally-occurring polymers (e.g., polysaccharides, starch and the like); microbial polyesters that can be degraded by the biological activities of microorganisms (e.g., polyhydroxyalkanoates and the like); conventional plastics mixed with degradation accelerators (e.g., mixtures having accelerated degradation characteristics such as photosensitizers); and chemosynthetic compounds (e.g., aliphatic polyesters and the like), Bio-PET, recycled Bio-PET, naturally photosensitive plastics and the like.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents.

Modifications may be made to the foregoing without departing from the basic aspects of the technology. Although the technology has been described in substantial detail with reference to one or more specific embodiments, those of ordinary skill in the art will recognize that changes may be made to the embodiments specifically disclosed in this application, yet these modifications and improvements are within the scope and spirit of the technology.

The technology illustratively described herein suitably may be practiced in the absence of any element(s) not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation, and use of such terms and expressions do not exclude any equivalents of the features shown and described or portions thereof, and various modifications are possible within the scope of the technology claimed. The term “a” or “an” can refer to one of or a plurality of the elements it modifies (e.g., “a reagent” can mean one or more reagents) unless it is contextually clear either one of the elements or more than one of the elements is described. The term “about” as used herein refers to a value within 10% of the underlying parameter (i.e., plus or minus 10%), and use of the term “about” at the beginning of a string of values modifies each of the values (i.e., “about 1, 2 and 3” is about 1, about 2 and about 3). For example, a weight of “about 100 grams” can include weights between 90 grams and 110 grams. Thus, it should be understood that although the present technology has been specifically disclosed by representative embodiments and optional features, modification and variation of the concepts herein disclosed may be resorted to by those skilled in the art, and such modifications and variations are considered within the scope of this technology.

Embodiments of the technology are set forth in the claim(s) that follow(s).

What is claimed is:

1. A reagent reservoir, comprising:
sidewalls each including a top edge and bottom edge; and
a trough including top edges, an inner channel and a base surface; wherein:
the top edge of each sidewall is connected to a top edge of the trough;
the base surface of the trough and the bottom edge of each sidewall are co-planar; and
the sidewalls and the trough comprise a polymer.

2. The reagent reservoir of claim 1, wherein the trough and/or sidewalls comprises an angled surface.

3. The reagent reservoir of claim 1, wherein the sidewalls comprise a substantially vertical surface.

4. The reagent reservoir of claim 1, wherein the trough comprises an inner channel which further comprises a base surface.

5. The reagent reservoir of claim 1, wherein the trough surfaces can comprise volumetric graduations.

6. The reagent reservoir of claim 1, wherein the trough is two or more troughs.

7. The reagent reservoir of claim 1, wherein an edge of the trough and an edge of the sidewalls is coextensive.

8. The reagent reservoir of claim 1, wherein an edge of the trough and an edge of a sidewall are connected by a joining surface.

9. The reagent reservoir of claim 8, wherein the joining surface is a substantially horizontal surface.

10. The reagent reservoir of claim 1, wherein terminal edges, formed at (i) the junction of trough inner surface edges and sidewall edges, and/or (ii) the junction of sidewall edges and substantially horizontal joining surfaces, comprise cutouts or depressions.

11. The reagent reservoir of claim 1, wherein the sidewalls comprise a flange, angled at about 90 degrees, with respect to the base of the substantially vertical sidewall.

12. The reagent reservoir of claim 1, wherein a trough base surface is coplanar with a sidewall bottom edge and/or a sidewall flange bottom or lower surface.

13. The reagent reservoir of claim 1, wherein the sidewalls are coextensive with bossed and/or detent regions.

14. The reagent reservoir of claim 1, wherein the trough inner channel is coextensive with substantially perpendicular bossed and/or detent regions.

15. The reagent reservoir of claim 1, wherein the bossed and/or detent regions comprise between about 1 and about 20 bossed and/or detent regions per sidewall and/or channel.

16. The reagent reservoir of claim 1, wherein the bossed and/or detent regions are embossed or detent in a shape chosen from, a wedge, an arch an ogive shape (e.g., pointed, curved surface), a groove, a double concave surface, changing radius arches, changing radius grooves, a pyramid, a V-shape and the like.

17. The reagent reservoir of claim 1, wherein the polymer is a biodegradable polymer chosen from naturally-occurring polymers (e.g., polysaccharides, starch and the like); microbial polyesters that can be degraded by the biological activities of microorganisms (e.g., polyhydroxyalkanoates and the like); conventional plastics mixed with degradation accelerators (e.g., mixtures having accelerated degradation characteristics such as photosensitizers); and chemosynthetic compounds (e.g., aliphatic polyesters and the like), Bio-PET, recycled Bio-PET, naturally photosensitive plastics and the like.

18. The reagent reservoir of claim 1, wherein the reservoir is formed from a polymer by a thermoforming process.

19. The reagent reservoir of claim 1, further comprising a biodegradable plastic in an amount that results in about 60 to 90 percent decomposition within about 60 to 180 days of being placed in a composting environment.

20. A reagent reservoir prepared by a process comprising:
contacting a mold with a polymer sheet; and
deforming the sheet on the mold, whereby a reagent reservoir is formed from the sheet; wherein the reagent reservoir comprises:
sidewalls each including a top edge and bottom edge; and
a trough including top edges, an inner channel and a base surface; wherein:
the top edge of each sidewall is connected to a top edge of the trough; and
the base surface of the trough and the bottom edge of each sidewall are co-planar.

21. The reagent reservoir of claim 20, wherein the polymer sheet has a pre-thermoforming thickness in the range of about 0.005 inches to about 0.050 inches.

22. A method for manipulating a reagent in a reagent reservoir, comprising:
introducing a reagent to a reagent reservoir; and
removing the reagent from the reagent reservoir; wherein the reagent reservoir comprises:
sidewalls each including a top edge and bottom edge; and
a trough including top edges, an inner channel and a base surface; wherein:
the top edge of each sidewall is connected to a top edge of the trough; and
the base surface of the trough and the bottom edge of each sidewall are co-planar.
